(19) United States
(12) Patent Application Publication
(10) Pub. No.: US 2002/0075844 A1
(43) Pub. Date: Jun. 20, 2002

(54) Integrating public and private network resources for optimized broadband wireless access and method

(76) Inventor: W. Alexander Hagen, Montara, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/832,679

(22) Filed: Apr. 10, 2001

Related U.S. Application Data
(60) Provisional application No. 60/256,158, filed on Dec. 15, 2000.

(51) Int. Cl. H04L 12/28

(52) U.S. Cl. 370/351; 370/328

(57) ABSTRACT

A system and method are disclosed for providing ubiquitous public network access to wireless, mobile terminals using private networks having private network access points and connections with the public network. The wireless, mobile terminals are permitted to use wireless, radio frequency communication devices comprising private network access points. A network access server (NAS) is associated with each wireless, radio frequency communication device and provides an interface between the wireless, mobile terminals and the private network. The NAS controls registration of wireless, mobile terminals as subscribers, and provides public network access to the mobile terminals through the private network's access point and public network connection. The NAS also restricts access by the mobile terminals to the private network, meters network useage by the mobile terminals, and controls use of bandwidth by the mobile terminals. The NAS also interfaces with integration operator distributed services over the public network. The integration operator services include databases and servers for storing and providing subscriber and network provider information for subscriber registration, network access and useage control, and accounting purposes. The NAS may be provided as a standalone element embodied in a computer, or may be integrated with the wireless radio frequency device and/or a network adaptor device for the private network.

### RELATED CASE

This application is related to and claims priority to provisional Application No. 60/256,158 entitled Integrating Public and Private Network Resources for Optimized Broadband Wireless Access and Method naming as inventor W. Alexander Hagen and filed Dec. 15, 2000. That application is incorporated herein for all purposes as if set forth herein in full.

### BACKGROUND OF THE INVENTION

1. Field of the Invention

The invention relates to digital networks generally. More specifically, the invention relates to the integration and interoperability of diverse private and public networks to provide ubiquitous broadband network access. Still more specifically, the invention relates to a system and method for providing and managing public network access by wireless, mobile terminals using the existing network connection resources of otherwise private networks.

2. Statement of Related Art

Present systems designed to provide wireless network access are limited by a number of factors. First, such systems are typically characterized by relatively large cell sizes which adversely affect signal quality and hence limit bandwidth. Typical cell sizes today are one mile or greater in radius. Economic considerations generally prohibit the construction and operation of cells at greater densities even though by reducing the radius of each cell, greater available spectral resources would become available. This would result both because the number of users a single cell would have to accommodate would be reduced, and because the signal quality would improve due to shorter distances between transmitter and receiver, thus reducing power requirements and permitting more efficient modulation schemes. Thus, such systems are generally ill-equipped to provide wireless, broadband network access.

Efforts are underway to develop so-called broadband wireless or “3G” networks. However, a number of serious problems have arisen. First, the proposed communication protocols have certain limitations that inhibit or even prevent broadband access. These limitations render such protocols particularly unsuitable for use in wireless local loop networks. The primary problem is that such protocols are designed for use with data communications at relatively high frequencies. However, data communications at such frequencies do not perform well over long distances, particularly to indoors or non-line-of-sight mobile terminals. Thus, in common useage, data rates commonly drop out of the “broadband” range and down to 128/64 kbps. In some circumstances, it may not be possible to successfully establish a network data connection at all. Second, the cost to build and operate networks in the frequency spectrum assigned for use by 3G networks, the so-called IMT 2000 band, is so high that such networks while technically feasible, may be economically infeasible. Third, the original plan for a single global band has thus far been unsuccessful, and has now been postponed to await development of so-called fourth generation or 4G global wireless access networks.

There are currently protocols available which are at least theoretically capable of supporting wireless, broadband network access. Such protocols include the Wireless LAN protocol specified in IEEE 802.11 and the proprietary Bluetooth protocol. The wireless LAN 802.11b protocol is designed to provide wireless communication at data rates of up to 11 mbps. Bluetooth is presently designed to provide such communications at data rates of approximately 1 mbps. However, these protocols also have a number of limitations which can render true widespread “broadband” wireless access difficult or impossible to achieve. Most notably, they are specifically designed for short-range wireless network communications and are unsuitable for establishing data links over long ranges, or in non-line-of-sight conditions. Thus, their ability to provide broadband wireless network access is typically limited to relatively short distances. Moreover, they only operate in the ISM (unlicensed spectrum) of 2.4 GHz where radio interference can be a problem. Thus, they are generally not able to provide broadband levels of performance in open environments where radio frequency signal interference is likely. Still further, there is presently no effective method available to allow users of such protocols, which are intended primarily for proprietary wireless LAN useage, to roam when away from their “home” network. That is, there is presently no “integrator” operator entity to logically connect the various proprietary and private wireless networks having wireless LAN and Bluetooth access points to provide ubiquitous connectivity for mobile users. Thus users can only receive the bandwidth benefits of these protocols in connection with accessing their own private home networks.

Finally, in the United States, there is a third network, called the Metricom network. This proprietary network is presently constrained to operation at 900 MHz, an unlicensed frequency, and does not presently have an effective system for dealing with radio interference problems. It also is limited to data rates of 128 kbps, making it unsuitable for wireless local loop applications. It is also limited by an apparent inability to deploy sufficient infrastructure for reliable nationwide coverage, and in any event the radio modems manufactured for it are useless outside the United States.

In short, while various forms of public and private wireless mobile access networks presently exist or are proposed, none is presently capable of providing true widespread wireless mobile network access at broadband data rates. Nor do present networks provide the ability for wireless devices to readily switch between cellular and private networks. A need to provide and manage such access clearly exists, and the present invention addresses that need.

### BRIEF SUMMARY OF THE INVENTION

The present invention provides a system and method that enables terminals to access public networks, such as the Internet, at broadband data rates, via fixed, wireline, or wireless network connections, and at geographically dispersed network access points using the existing public network connections of private or proprietary networks. The present invention thus effectively integrates diverse private and public networks to provide ubiquitous, network access at broadband data rates using existing infrastructure.

According to the invention, a plurality of network access points are provided at geographically dispersed locations. Some or all of such network access points may be wireless access points. A network access server (NAS), which may be software, hardware, or a combination of both, functions as an intermediary or interface between one or more such wireless access points and the existing public network connection resources of an associated, otherwise private network. The NAS provides and manages public network access for authorized terminals, including mobile, wireless terminals, using the existing public network connection of the associated private network, while also preventing unauthorized access to the private network by such terminals.

The NAS may provide a variety of network access and management features including registration of subscribers, metering of network activity for accounting and billing purposes, and monitoring and control of bandwidth useage by authorized subscribers.

Another aspect of the invention is the provision of integration operator distributed services (IODS). The IODS provides master facilities for accounting, user authorization and security, as well as NAS management and control. The IODS and the various NAS′ of the system communicate remotely over the public network. The IODS and NAS′ in combination provide a geographically dispersed, ubiquitous access, publicly accessible, distributed network system.

A particularly advantageous feature of the invention with respect to mobile wireless terminal network access is that it greatly reduces the average distance between wireless, mobile terminals and their wireless network access points, thereby greatly improving the quality of network connections and data communications while reducing transmission power requirements, reducing data error rates, and consequently improving data rates. In so doing, the invention achieves the ability to provide true widespread broadband network access for wireless, mobile terminals.

Still another advantageous feature of the invention is that it does not require additional software be added or alterations be made to existing terminals or network access devices, including wireless terminals and devices. The NAS and IODS handle configuration requirements, connections, registration, security, accounting, settlements, management and other functions transparently. Thus, the present invention takes advantage of existing infrastructure and devices.

Still another advantageous feature of the invention is that it does not require manually reconfiguring the network adaptor of a terminal each time the terminal connects to a new network access point, even if the network access point is not located in the terminal's “home” network. The NAS and IODS handle configuration functions transparently at the logical network layer.

Still another advantageous feature of the invention is that the terminals require no special software or hardware beyond the current standard software and hardware for network data communications, including wireless network communications. The NAS transparently handles terminal registration, authentication, and network access processing.

Additional features and advantages of the invention will become apparent by reference to the following detailed description of the preferred embodiments taken in connection with the drawings.

### BRIEF DESCRIPTION OF THE DRAWINGS

FIG. 1 is a block diagram of a presently preferred system architecture according to the invention.

FIG. 2 is a block diagram illustrating the elements of a presently preferred integration operator database.

FIG. 3 is a block diagram illustrating the elements of a presently preferred network access server.

FIG. 4 is a block diagram illustrating the elements of a preferred gatekeeper service of the network access server of FIG. 3.

FIG. 5 is a block diagram illustrating the functional elements of the presently preferred integration operator distributed services.

FIG. 6 is a flow diagram illustrating a high-level process flow in the system of FIG. 1.

FIG. 7 is a flow diagram illustrating the details of establishing a communications link between a wireless, mobile terminal and a wireless access point device.

FIG. 8 is a flow diagram illustrating the details of authenticating and authorizing a wireless, mobile terminal.

FIG. 9 is a flow diagram illustrating the details of processing user profiles to authorize network access by and to allocate network resources to wireless, mobile terminals.

FIG. 10 is a flow diagram illustrating the details of managing network sessions by wireless, mobile terminals and performing network accounting.

FIG. 11 is a flow diagram illustrating the details of providing IP address assignments to authorized wireless, mobile terminals to enable network communications.

FIG. 12 is a flow diagram illustrating the details of certain security procedures including detection of fraudulent network useage and unauthorized network intrusion.

FIG. 13 is a block diagram illustrating an alternative preferred system architecture according to the invention.

FIG. 14 is a graphical illustration showing various options for providing encrypted network communications between wireless, mobile terminals and various elements of the system.

FIG. 15 is a flow diagram illustrating optional voice/call processing in the system.

FIG. 16 is a block diagram illustrating the elements of an alternative preferred embodiment for a wireless access point/network access server employing wireless telephony components.

FIG. 17 is a block diagram illustrating the preferred data elements for a bandwidth allocation manager functionality of the network access server.

FIG. 18 is a graphical illustration of an exemplary bandwidth parameter scheme for use in connection with the bandwidth allocation manager data elements depicted in FIG. 17.

FIG. 19 is a flow diagram showing a preferred process of bandwidth allocation management by the network access server.

### DETAILED DESCRIPTION OF THE INVENTION

### DESCRIPTION OF THE SPECIFIC EMBODIMENTS

The preferred embodiments of the present invention will now be described in detail with reference to the drawings, in which like elements are identified by the same references. The following description is exemplary and not limiting.

In general, the radio link terminology used herein is based on the IEEE 802.11b standard for Wireless Ethernet. However, the principles and implementations described herein are not intended to be limited to any particular wireless network communication protocol, but rather are intended to take advantage of any appropriate broadband wireless network communication protocol, including but not limited to the Wireless LAN protocol specified by IEEE 802.11 and the Bluetooth protocol, recently adopted as IEEE 802.15.

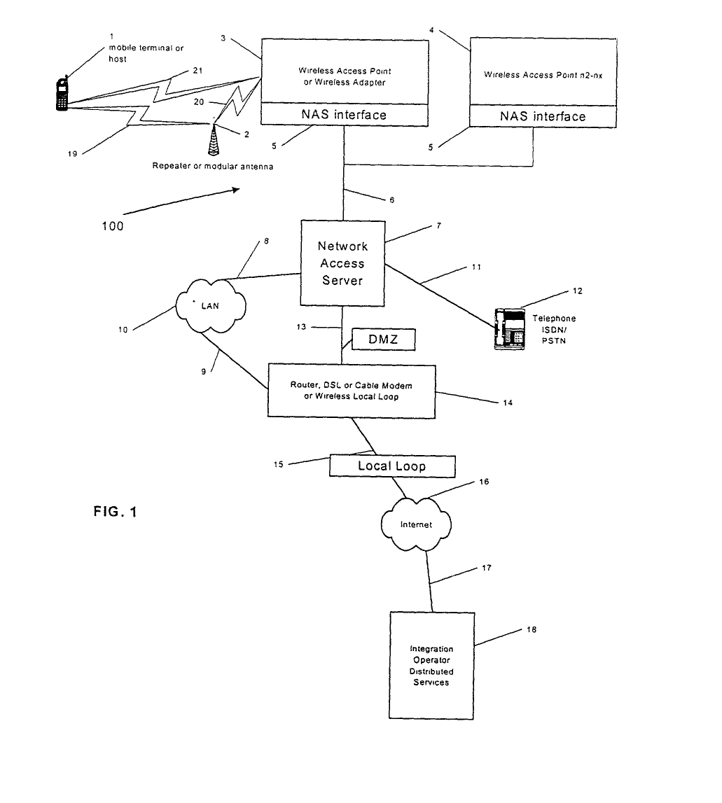

Referring to FIG. 1, there is shown a functional block diagram illustrating a presently preferred system 100 embodying the invention. The primary purpose of the system 100 is to provide mobile, wireless terminals 1 with access to network resources, although it can also provide such access to fixed or mobile terminals over wireline connections as well. Mobile, wireless terminal as used herein means any mobile, wireless terminal having a MAC or other unique equipment address, such as a digital cellular handset, wireless PIA or PDA, or a computer with a wireless network adaptor. Other fixed and mobile terminals which may take advantage of the services provided by the system 100 include desktop and laptop computers and the like, particularly when visiting and connecting to a foreign network.

Mobile wireless terminal 1 communicates with the system 100 directly via radio waves 21 using conventional wireless network communication technology. Alternatively, if additional range is required or desired, a conventional repeater or external antenna 2 may be provided to receive and transmit radio waves 19, 20 between the mobile terminal 1 and the system 100.

The system 100 generally comprises one or more geographically dispersed network access points, which in this embodiment are radio frequency wireless access points (WAP) 3, 4. The WAPs 3, 4 may be conventional devices equipped with wireless network adaptors embodying the IEEE 802.11 Wireless LAN or Bluetooth wireless network communications standards, or other devices providing similar functionality. Examples of such devices include the Home Wireless Gateway product sold by 3COM Corporation, the Spectrum High Rate AP 41X1 Ethernet Access Point product sold by Symbol Technologies, and the Aironet 340 Series Access Points product sold by Cisco Systems.

The system 100 also preferably includes one or more network access servers (NAS) 7. The NAS 7 may be implemented in software or a combination of software and hardware as described in detail herein. The NAS 7 is an intermediary network component that primarily functions to provide mobile terminals 1 with access to the public network, i.e., Internet 16, using the public network connections of otherwise private networks, such as LAN 10. The NAS also controls and manages access to such private networks by such mobile terminals 1. Thus, as described in detail herein, the NAS performs registration, authentication, and other functions necessary to provide visiting mobile terminals with access to the public network 16, while simultaneously controlling access by such visitors to the local private network 10, whose public network connection resources are being used to provide such access. The NAS 7 also preferably provides such services as bandwidth allocation management, quality of service management, network useage accounting and settlement, provision of voice/telephony services via telephony equipment 12, and others.

While only one NAS 7 is shown in the exemplary system 100, persons skilled in the art will appreciate that multiple NAS′ may be employed to interface multiple WAPs 3, 4 to one or more private networks 10 and the public network 16. Similarly, while WAP 4 is illustrated without a corresponding mobile terminal 1 or repeater/antenna 2 associated with it, this is simply for ease of illustration.

Persons skilled in the art will appreciate that each WAP represents a wireless network access point and that the WAPs may be provided at various geographical locations, each being provided with its own repeater/antenna 2 if desired or necessary. Thus, each WAP 3, 4 provides a point of wireless network connection for one or more mobile terminals 1. Additionally or alternatively, multiple WAPs 3, 4 may be provided in the same geographic location and each WAP may be configured for a different wireless network protocol to accommodate mobile terminals 1 of different types and/or by different manufactures and/or to interface to different private networks. Thus, for example, one WAP 3 may be configured for wireless LAN communication according to the IEEE 802.11b standard for Wireless Ethernet and another WAP 4 may be configured for wireless communication according to the Bluetooth standard. Alternatively, a single WAP device may be configured to provide support for a variety of different network communication protocols.

Persons skilled in the art will also realize that while one private LAN 10 is illustrated in the exemplary system, a plurality of geographically dispersed private networks may make up a distributed network, each having associated therewith one or more WAPs and one or more NAS′. Each NAS may serve a number of WAPs configured for the same logical network or subnetwork.

The system 100 preferably also comprises remote integration operator distributed services (IODS) 18. The IODS 18 is referred to as providing “distributed services” because it is preferred that such services be provided by one or a plurality of networked servers employing one or more linked distributed relational databases, among other things. Preferably, the IODS 18 communicates remotely with the NAS′ 7 via the public network 16 and any intervening local loop 15 and router, modem or other network connection 14 at the NAS′ end. The network connection 14 may comprise the public network connection of a private LAN 10, with which the NAS 7 is associated, or a separate connection dedicated to the NAS 7.

Generally, when a mobile terminal 1 comes into radio range of a WAP 3, 4 either directly or via a repeater 2 it will send a request to establish a link. The WAPs 3, 4 simply accept the link requests while the NAS 7 manages network access. Once a communications link is established between the mobile terminal 1 and the WAP 3, the WAP 3 functions as a communications link between the NAS 7 and the mobile terminal 1. The NAS 7 initially functions to identify and if necessary register the roaming terminal as a subscriber. When the mobile terminal 1 attempts communication on the network, the NAS receives a layer 3 packet containing the mobile terminal's MAC address. The NAS looks this address up in a local database to determine whether the mobile terminal is a registered and authorized user. The NAS 7 may also communicate with the IODS 18 to identify the mobile terminal 1, and to determine its authorization and network access parameters, among other things. The NAS 7 maintains a local database, which together with the IODS 18's database provides security, accounting and similar data to enable the NAS 7 to perform these functions. For example, if the NAS does not find the address in its local database, it may query a master database located in the IODS 18. Both databases are described in detail herein.

During the initial connection process, secure encrypted communications may be set up between the mobile terminal 1 and the WAP 3. If the WAP 3 can be accessed and controlled programmatically, the NAS 7 can program the WAP 3 to accept requests to establish an encrypted layer 2 (link layer) connection with a visiting mobile terminal 1. Thus, the WAP 3 preferably includes or is provided with a Network Access Server Interface 5, which enables the NAS to communicate with and program the WAP. Preferably the NAS interface 5 is enabled to receive control commands from the NAS 7 via conventional simple network management protocol (SNMP) or a similar protocol. A suitable programmatically accessible API is currently available from Symbol Technologies as SpectrumSoft WNMS 2.0. Because different manufacturers of WAP devices handle link layer encrypted communication sessions differently, some mobile terminals configured to enable link layer encrypted sessions may be incompatible with a particular WAP. In order to maximize the compatibility between WAPs of different manufacturers, it is preferred that the extended service set ID (ESS ID) (wireless domain name) for all WAP-containing networks be the same, for example “wan.” When a mobile terminal communicates with a WAP on its own home network, its wireless network adaptor will preferably be configured to use conventional wireless encryption protocol (WEP) at the strongest level of encryption possible. However, when the mobile terminal is away from its own home network and seeking to establish a communication link with a foreign network's WAP, it's WEP setting will preferably be toggled to a no security mode to ensure successful connection. Therefore, the WAPs should preferably accept both requests for encrypted and open sessions so that mobile terminals that cannot establish a link layer encrypted session can nevertheless establish an open session.

If the mobile terminal 1 is found to meet predetermined criteria and thus to be authorized to have network access, the NAS 7 will function as an intermediary between the mobile terminal 1 and the public network connection 14 of the NAS′ associated private network 10 to enable the mobile terminal 1 to connect to and communicate over the public network 16. Generally, if the mobile terminal's MAC address is registered with the operator as a subscriber authorized to use the network, a stored subscriber profile corresponding to the owner of the MAC address is retrieved, cached in the NAS′ local database, and processed by the NAS to determine the network access and bandwidth parameters for which the subscriber is authorized, the subscriber's assigned quality of service (QOS) level, any applicable security policies in force, etc. The NAS also initiates statistics gathering for billing purposes, and initializes a session record in its local database.

In addition to confirming the mobile terminal is authorized and allocating network resources to it, the NAS preferably provides additional services. For example, it preferably ensures that any communications between private LAN 10 and mobile terminal 1 are suitably encrypted. Thus, the NAS 7 preferably verifies that encryption has occurred prior to enabling forwarding between the roaming access network segment 6 and the private LAN network segment 8. Additionally, the NAS preferably performs functions such as metering the mobile terminal's network useage for accounting purposes and managing and restricting access by the mobile terminal 1 to the private network 10 as appropriate. The NAS also preferably supports voice/telephony communications by the mobile terminal. For example, the mobile terminal may activate an IP telephony or VoIP client to enable the subscriber to make voice or video calls over the network. The NAS preferably is provided with a telephony gateway and agent which support such access and facilitates connection via the network, an ISDN interface or the public switched telephone network (PSTN) interface 11, 12, if the NAS.

If the mobile terminal's MAC or other equipment address is not located in either the NAS′ local or the IODS′ master database, the only network access the mobile terminal is permitted is to the NAS. In that case, the NAS assigns the mobile terminal a temporary IP address using conventional DHCP and/or DHCP relay services, but all network communications by the mobile terminal are redirected to the NAS, which offers to register the host as a subscriber to the integration operator's network, i.e., the set of private and public networks integrated by the integration operator via the IODS and NAS′. The NAS preferably maintains an HTTP server for this purpose to communicate a registration page to the mobile terminal. The registration page may be a simple HTML page that requires the mobile terminal to provide registration information including, for example, a credit card number, billing name and address, etc.

Persons skilled in the art will appreciate that the ability of mobile terminal users to wirelessly access the Internet via any one of multiple geographically dispersed WAPs while absent from their home networks and using the Internet connections of otherwise private local networks greatly expands access to the Internet, and provides a great convenience, as well as the potential for enhanced productivity. A particularly advantageous feature of the invention is that it operates using existing conventional mobile terminals 1. No special software need be added to the mobile terminals beyond that normally required for conventional wireless network communications in order to establish communication links with WAPs 3, 4 and NAS 7, wherever they are implemented, and to thereby access the Internet.

The NAS 7 may be implemented as a stand-alone device or integrated with a WAP 3, 4, interface 14, or both. In the case where the NAS 7, WAP 3, 4, and interface 14 are integrated, the preferred embodiment is to employ a general purpose computer. In this embodiment, the NAS is implemented as a software module or subsystem that interoperates with and runs under the UNIX, WINDOWS, or LINUX operating systems or a similar operating system. In this embodiment, the NAS preferably also runs in cooperation with appropriate firewall, network address translation (NAT), HTTP, and perhaps Mobile IP software components. Alternatively, some or all of these well-known software elements may be incorporated in the NAS software itself. The computer will have a wireless network adapter which functions as the WAP, and a second network adapter that connects to the local loop 15 and functions as the interface 14. In this embodiment, if Wireless LAN is being used as the protocol for communicating with the mobile terminals, it is necessary either that the mobile terminal be configured to ad hoc mode to communicate with the WAP in a peer-to-peer session, or that a suitable software access point module be provided on the computer if the mobile terminal is to communicate with the WAP in infrastructure mode. Such software access point software is available from a number of companies, including the WL300 Wireless LAN Software Access Point product sold by Compaq Computer.

Current WAP devices by different manufacturers have different configurations. Thus, if the NAS is to be integrated with a WAP, a different embodiment of the NAS may have to be configured for each different WAP. However, this embodiment has the advantage that no physical device needs to be inserted between the WAP and the local loop 15.

If the NAS is integrated with the interface 14, it is preferably implemented as a general purpose computer with a cable modem, ISDN, or DSL card as one network interface. Alternatively a router can be used if it supports LDAP or other directory services requirements. The other network interface can be a wireless adaptor, cable modem, or ISDN/T-1 card. By providing a third network adaptor, this embodiment can provide a completely secure internal network in addition to wireless access and uplink to the public network. The advantage of this embodiment is that essentially all network activities are housed in a single device.

The most preferred embodiment presently, however, is to segregate the network into three logical network segments. In this implementation, the NAS 7 is embodied in a general purpose computer having three network interfaces. The first network interface is to downlink 6, which provides connectivity to mobile terminals via its associated WAP 3, 4. The second network interface is to uplink 13, which provides connectivity to the public access network, i.e., Internet 16. Preferably, the second interface and uplink 13 provide a data path from the NAS to the Internet, which is free of any firewalls or similar data restriction mechanisms, hence the designation of this interface as a DMZ. The third network interface 8 connects the NAS 7 to the private network, i.e., LAN 10. This connection is preferably protected via an IP filter or more preferably a complete firewall to control and limit or prevent access by the mobile terminal 1 to the private network 10. The IP filter preferably is configured to contain the IP address information necessary to permit those mobile terminals 1 which are authorized to access the private LAN 10 to do so through NAS 7, while denying access to unauthorized mobile terminals. For example, the LAN 10 may be the internal private corporate network of a local resource provider, i.e., the operator of the network through which the mobile terminal is given access to the public network. The resource provider may determine that in addition to hosting unknown or foreign mobile terminals 1, which are not to be provided access to LAN 10, the resource provider will also host mobile terminals 1 which the resource provider owns or for other reasons has determined to provide access to LAN 10. In such case, the IP filter or firewall may be configured such that communications to or from IP addresses corresponding to mobile terminals owned by the resource provider or otherwise permitted to access LAN 10 will be permitted access, whereas communications to or from unknown or foreign IP addresses will not. Numerous commercially available firewalls and IP address filters are suitable for this purpose and need not be described in further detail here.

In the foregoing implantation, the LAN 10 may also have a direct connection 9 to the public network interface 14, e.g., router or DSL connection. This permits the LAN's own internal client nodes or a mobile terminal host with access rights to LAN 10 and connected to LAN 10 via NAS 7 to bypass the NAS′ control of public network access and to access the public network 16 directly. Accordingly, it is preferred for network connection 9 to also have a firewall implemented at the interface 14.

An alternative preferred system architecture is shown in FIG. 13. This architecture is similar to the architecture shown in FIG. 1. A primary difference is that the NAS 7 does not have a direct network connection to the WAPs 3, 4 or the private network 10. Instead a network hub or router 19 is connected between the WAPs 3, 4 and the private network's router, modem, etc. 14. The NAS 7 operates as another network node connected to the hub or router 19 on the same network or sub-network. In this architecture, the WAPs 3, 4 communicate with the router, modem, etc. 14 of the private network 10 via the hub or router 19. The NAS also communicates with the private network 10 via the hub or router 19 and the private network's router, modem, etc. 14. The NAS also communicates with the WAPs 3, 4 via the hub or router 19. The NAS continues to communicate with the IODS 18 via the private network's router, modem, etc. 14 as in the architecture of FIG. 1, although the hub or router 19 is now an intermediary node in that path. In this architecture, the NAS does not itself route packets, but relies on the hub or router for that functionality. However, the NAS preferably has programmatic control over the hub or router in order to query the hub or router and to control the SNMP, ARP, IP filter and bandwidth allocation parameters thereof appropriately. The functionality of the NAS, the IODS, and the WAPs is otherwise essentially the same as described with respect to FIG. 1.

This architecture is particularly suitable where there are potentially a relatively large number of users and/or where the users include both public and private net users, and it is desired to keep them separated. Thus, for example, in this embodiment, public network access subscribers using wireless, mobile terminals 1 may be permitted access to the public network only via publicly accessible WAPs 3, 4. For these users, the only point of access to the private network 10 is through the network's own router 14, which is easily secured by the network administrator. At the same time, private network users/clients may be permitted to access the private network 10 via wireline network connections or via wireless mobile terminals 23 through private WAPs 21. Private WAPs are preferably maintained at locations that are not publicly accessible or are otherwise configured to limit access to authorized clients of the private network 10. These users can then gain access to the public network through the private network's router 14.

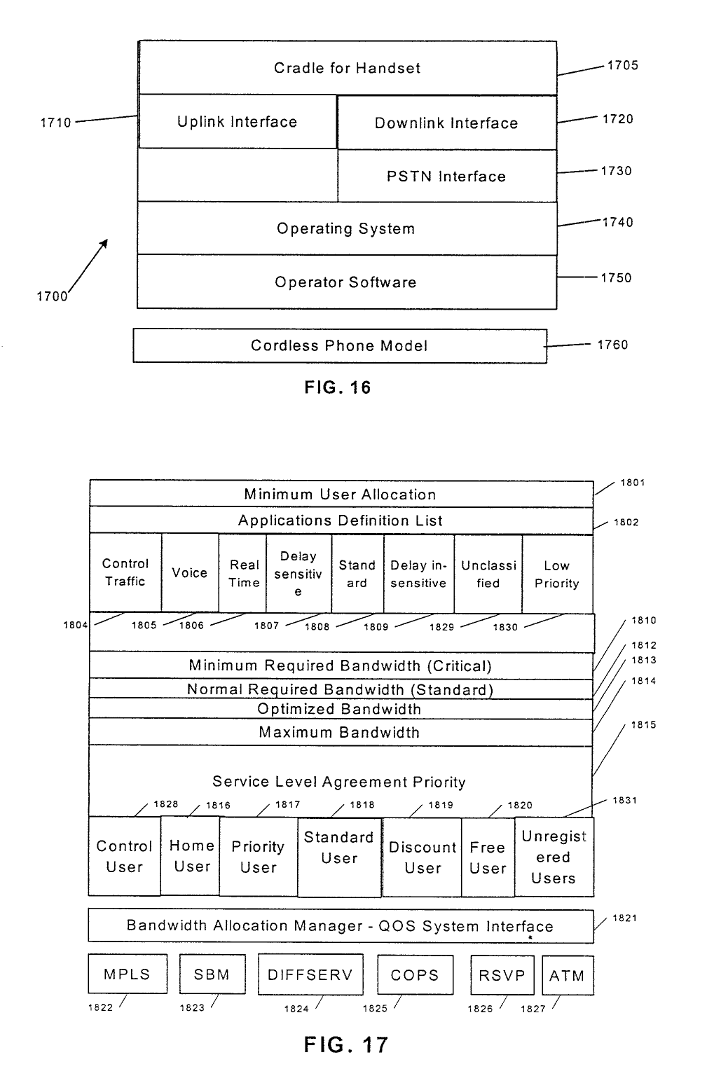

Still another possible embodiment of the NAS is shown in FIG. 16. In this embodiment 1700, the NAS is integrated in a wireless phone. Preferably in this embodiment, the NAS components, i.e., the uplink network interface 1710, the downlink network interface 1720, and telephone (PSTN) interface 1730 are all integrated in a handset base or cradle 1705. A general purpose programmable microprocessor preferably implements an operating system 1740 and operator software 1750, such as various application programs, as well as the NAS software. The wireless phone handset 1760 is preferably implemented as a personal digital assistant (PDA) device including a display screen for displaying data, and input entry keys for entering phone numbers as well as data. It is also preferred that the handset 1760 be battery powered and that the cradle 1705 be provided with a conventional electrical connection, electrical connectors for connecting to the handset 1760, and a recharging circuit so that the cradle and handset can be interfaced to recharge the handset as necessary.

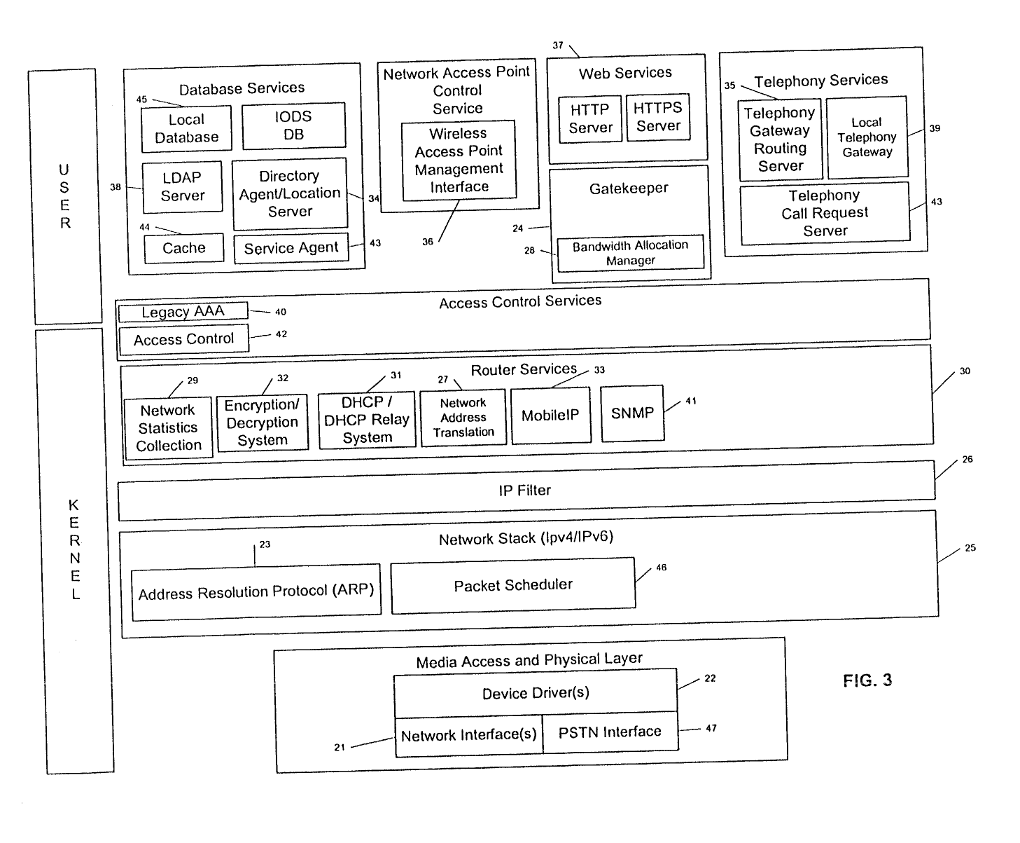

Referring to FIGS. 3, 4, and 15-19, the preferred embodiment of NAS 7 will be described in greater detail. FIGS. 3, 4, and 15-19 illustrate the NAS 7 in the preferred embodiment where the NAS is a separate physical element from the WAP 3, 4 and network interface 14. However, as described previously, the NAS may be integrated with one or both devices if desired. At the lowest level (media access and physical layer), the NAS includes components necessary to physically connect to the network. As described previously, the NAS 7 will have at least two conventional network interfaces 21. One is a downlink interface for communicating with mobile terminals 1. The other is an uplink interface for connecting to the public network, i.e., the Internet. Additionally, a third conventional network interface 21 is preferably provided for connecting to the private network 10. Conventional device drivers 22 are provided in connection with the network interfaces 21 to convert multiplex/de-multiplex layer 2 (link layer) data to layer 3 (network layer) data. Preferably, the NAS also has an interface 47 to the public switched telephone network (PSTN) and an associated device driver 22. Although illustrated separately in FIG. 3 for clarity, those skilled in the art realize that device drivers 22 are typically part of the network interfaces 21 themselves.

At the next level (network layer), the NAS recognizes and processes conventional packetized network traffic as it traverses the network via conventional TCP/IP addressing and routing. A conventional network stack 25 implements a conventional address resolution protocol subsystem (ARP) 23 and packet scheduler subsystem 46 to provide this functionality. The network stack may embody either the IP version 4 or IP version 6 standard, although more preferably stacks supporting both standards will be provided. An IP version 6 standard may have some advantages with respect to certain applications such as IPSec and some free voice-over-IP (VoIP) applications, which tend to not function as well with current conventional network address translation software embodying the IP version 4 standard.

The ARP subsystem 23 receives packets from the mobile terminals 1 via WAPs 3, 4, reads their MAC addresses from the headers for use by other NAS software components, and caches those addresses. Such software is conventional and is widely available. If the software source code is available for ARP 23, it is preferable to modify it so that the ARP 23 passes any new MAC addresses received to the gatekeeper 24 component of the NAS, described below. If available, this provides a performance benefit in that the gatekeeper 24 need not incur the overhead associated with polling the ARP cache for new MAC addresses.

An IP filter 26 or alternatively a firewall preferably processes all packets entering the NAS and directed to the public or private network. When a registered mobile terminal is authenticated, based on its MAC address being found in the NAS′ local database or in the IODS master database, an IP address corresponding to the MAC address is explicitly enabled. Packets whose IP address headers contain addresses corresponding to previously registered and authenticated mobile terminals are forwarded. Those that do not are preferably discarded. If filtering based on MAC address is available, it can be used instead of or in addition to IP-based filtering, as a safeguard against intruders.

The NAS also preferably implements a number of router-related services 30 at the network level. The router services 30 provide host configuration, network data collection, IP-based routing, mobile roaming and network management functions. The router services must support ICMP router discovery messages (RFC 1256) and other standard router requirements specified in the published IETF RFC 1812 and IP version 6 RFC 2460 standard. The NAS router-related services preferably include network address translation 27, network statistics collection 29, DHCP/DHCP relay services 31, encryption/decryption services 32, mobile IP support 33, and SNMP network management services 41.

Conventional network address translation (NAT) 27 software dynamically provides routable IP addresses for registered, authenticated mobile terminals as needed. NAT 27 may not be needed if a resource provider has sufficient permanent IP addresses available to supply visiting mobile terminals, as well as local users. However, that is not usually the case.

The network statistics collection component 29 preferably maintains a count of all bits sent and received by the IP/MAC address corresponding to each registered, authenticated mobile terminal accessing the network. Preferably, when an IP address is allocated to a registered, authenticated mobile terminal, the NAS initializes a record in its local database with a time stamp. Upon completion of a session and disconnection by the mobile terminal, the NAS updates the record with another time stamp. The record is preferably also updated with the total number of bits sent and received during the session, as well as any retransmissions. This information is cached at the NAS and periodically the NAS uploads these records to the IODS 18 over the public network. This information is useful for accounting and billing purposes, such as permitting subscribers to check their bills, as well as for allocating revenues among local service providers and the like, if desired. A number of conventional software facilities are available to carry out the network statistics collection functionality. For example, MicroSoft Windows NT and Windows 2000 operating systems each provide a performance monitor API that can collect such information programmatically. Similar API's exist for other suitable operating systems that support networking.

The DHCP/DHCP Relay Agent 31 component preferably either dynamically provides host IP configuration within the NAS itself, or acts as a transfer agent to an external DHCP server for such configuration. Preferably, the DHCP configures at least two subnetworks. One is an untrusted or unsecure network for public access. The other is a secure network for private only access. For example, DHCP 31 would set up a 10.0.X.X unsecure sub-network and a 10.0.Y.Y secure sub-network. Authorized users of the private network 10 would use the secure sub-network to access the private network, which is preferably behind a firewall. The appropriate sub-network is assigned to each mobile terminal subscriber by the NAS, based on the NAS′ determination whether the mobile terminal subscriber user is an authorized client of the private network 10 or a public network access only subscriber. Appropriate discrimination between private network clients and public access only subscribers can be achieved by establishing and maintaining pre-arranged address reservations in the DHCP for specified mobile terminal equipment addresses, or alternatively by arranging and permitting the DHCP server to have programmatic access to mobile terminal network adapter address tables in the NAS. In the preferred embodiment, a DHCP relay is used rather than maintaining a DHCP server as part of the NAS itself. The use of a DHCP agent avoids scalability issues that may arise when DHCP parameter modifications are made. Alternatively, however, a distributed DHCP database can avoid scalability problems as well. The preferred arrangement of the DHCP/DHCP agent component assumes the network complies with IP version 4 standard. A similar arrangement can be implemented for IP version 6 networks, except in that case there is no need to use private IP, and IP addresses will be self-configured based on information provided by the NAS, as specified in the IETF RFC's for IP version 6.

The encryption/decryption component 32 preferably comprises facilities to provide authentication and secure encrypted communications between the NAS and mobile terminals, if available, and between the NAS and the IODS, especially for transmitting proprietary and sensitive data such as accounting data. The preferred implementation employs conventional Internet security protocol (IPSec) and a conventional authentication/encryption/decryption facility or ISAKMP/IKE, operating with a conventional public key infrastructure (PKI) digital certificate service. Alternatively, secure sockets layer protocol (SSL) may be used. As known to those skilled in the art, IPSec is preferably operated in tunnel mode to create a secure communication tunnel between the NAS and the IODS, thus establishing a virtual private network (VPN), and encapsulating data transmitted between the NAS and the IODS. The ISAKMP/IKE facility facilitates mutual authentication between the NAS and IODS, and the negotiation of mutually acceptable cryptographic algorithms and keys to enable encryption and decryption of the transmitted and received data respectively. SSL provides similar functionality. Cryptographic certificates and keys are suitably obtained via a conventional certificate service, many private and commercial sources being well known in the art. The IPSec tunnel may also be used to pass traffic from a mobile terminal through the network to either the operator network gateway closest to the final destination (operating IPSec in tunnel mode), or to the final destination itself (IPSec operating in transport mode). As described herein, an essentially identical set of facilities is preferably provided as part of the IODS.

The NAS′ Mobile IP component 33 preferably provides support for mobile terminals embodying the Mobile IP standards specified in the published IETF RFC 2002, Mobile IP version 4 standard. Mobile IP version 4 support offers the ability to maintain a session with a suitably equipped mobile terminal even though the mobile terminal changes its point of connection to the network. Thus, with Mobile IP version 4 support, a mobile terminal can remain in communication with the network even though its network connection passes from one NAS to another during the session. NAS′ embodying mobile IP support according to the Mobile IP version 4 standards work out the hand-off of the mobile terminal's network connection from one to another, and the rerouting of packets to and from the mobile terminal and a correspondent node over the network.

The simple network management protocol (SNMP) 41 component comprises a conventional SNMP network protocol interface. The NAS preferably employs the SNMP protocol to programmatically control the WAPs, and to pass security alerts, error messages and other network control and management messages between the various components of the NAS and IODS over the network.

At the next level, the NAS preferably includes access control services. The access control services preferably include a legacy authentication, authorization and accounting (AAA) service 40 and an access control component 42.

AAA service 40 is an optional component that is preferably provided to accommodate mobile terminals equipped for pre-IPSec Radius (published as IETF RFCs 2165 and 2865) or Diameter network authentication and access control standards and/or services. For such mobile terminals it is preferred that Radius or Diameter service be enabled to permit them access to the network and the ability to engage in secure encrypted sessions.

Access control component 42 preferably includes a list of network users who are permitted supervisory access to administer the system. This list will typically be generated by the resource provider when configuring the NAS. Typical users having supervisory access would be limited to the resource provider and the integration operator and their agents. This component is commonly and preferably implemented by the operating system. For example, in Windows NT it is based on the Security Account Manager (SAM) system.

At the application level, the NAS preferably provides database services, network access point control services, web services, and telephony services. Perhaps most importantly, the NAS also implements at this level a gatekeeper 24, which functions as a sort of master process controller.

The database services are provided by the NAS′ local database 45, which is a replication of portions of the IODS master database, a directory agent/location server 34, a cache 44, a service agent 43, and a light-weight directory access protocol (LDAP) server 38.

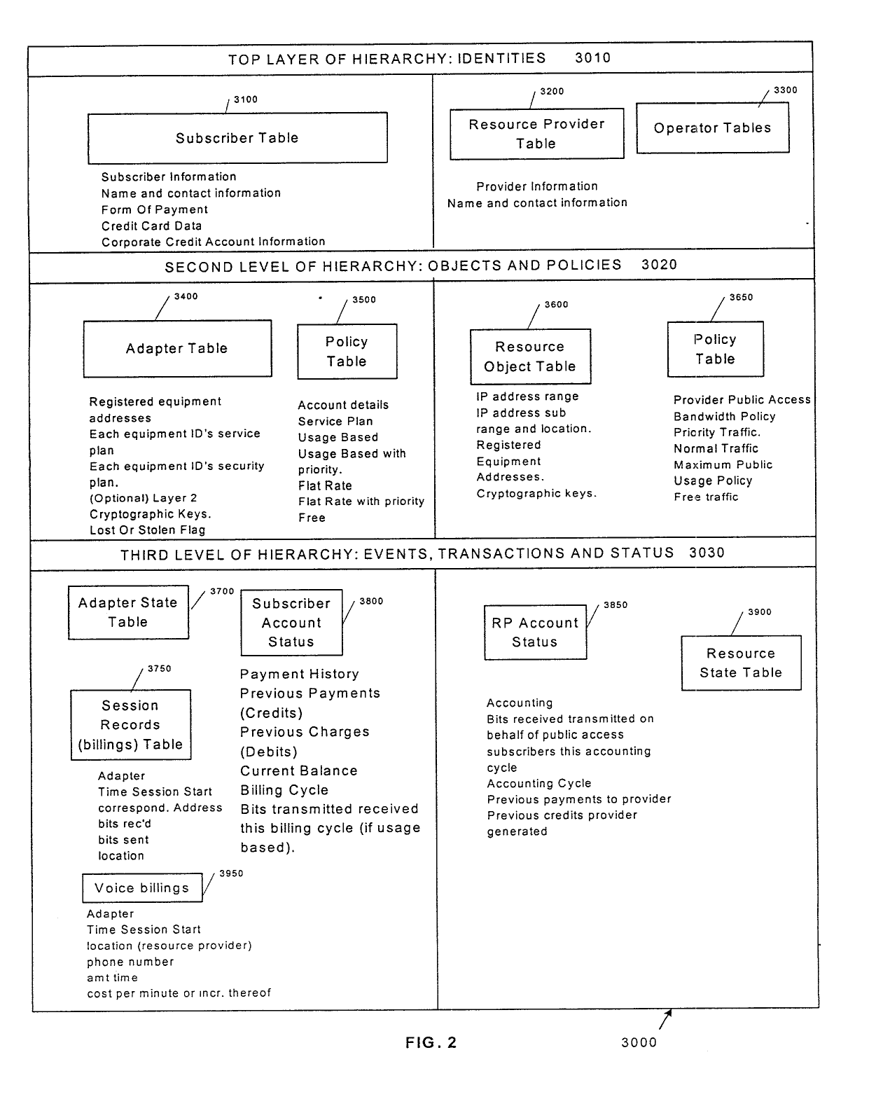

The NAS local database 45 preferably stores a copy of the IODS master database as shown in FIG. 2. However, preferably only records for the resource provider's home users, i.e., private network clients, and data pertaining to the resource provider's network are normally maintained in the local database. Those with knowledge in the art can construct any number of synchronization and replication schemes between the IODS master database and the NAS′ local database for storing information concerning visiting mobile terminals, or terminals that have recently visited the network or are in the area of the NAS. If the local NAS has sufficient network resources, and if there is sufficient bandwidth available, it could attempt to maintain synchronization with one or more of the datasets shown in FIG. 2, and more particularly the subscriber and adapter tables. It is possible, but unlikely that the resource provider will need or wish to synchronize the session record and accounting record information, and in some implementations the IODS might even lock such information and prohibit it from being downloaded to the NAS local database for security reasons.

Directory agent/location service 34 is a standard component of the conventional Service Location Protocol published as IETF RFC 2608. This service returns information about network resources to inquiring users. It is required to locate parties' Internet Location Server (ILS) and session initiation protocol (SIP) information.

The cache 44 is preferably a conventional cache used by the NAS components to store and retrieve information concerning mobile terminals connected to or connecting to the network. Such information preferably includes the subscriber's service level agreement, as well as equipment address information. The NAS preferably updates its local database 45 periodically from the cache, as well as updating the IODS master database.

Service agent 43 acts as an interface between the directory agent 34 and the service requestor as specified in the published IETF RFC 2608 standard.

The LDAP server 38 is a conventional server that functions as an intermediary between network clients, e.g., a mobile terminal in this case, and an LDAP directory or database of network resources. A conventional LDAP directory typically contains email contact information for network clients, as well as the identity and location of network services and devices. In the present preferred embodiment, this information is preferably replicated from the IODS to the local NAS copy. In addition, the resource provider's entire dataset is preferably provided by the resource provider when configuring the NAS. Preferably, a database query processing server is provided to permit the data to be accessed and modified by the resource provider and/or the integration operator. The LDAP database should contain the adapter, subscriber, and resource provider tables identified in the IODS database in FIG. 2. It may also contain the session and billing records from the IODS database. If desired, the session and billing records may be handled by a second database query processing server which commits the same to the same database, perhaps using a different data schema. The LDAP database 38 also preferably contains at least the following additional information:

1. The metering records generated by network statistics collection component 29;

2. Bandwidth allocation parameters for visiting mobile terminals;

3. Cryptographic keys of the integration operator and users who will use encrypted network communications;

4. IP address of the IODS.

5. Accounting records for voice telephone calls, e.g. originating caller identification, telephone number called, and length of call.

6. DHCP configuration information (optional);

7. IP filter parameters (optional);

8. Pointer to public key version used to encrypt records (preferably, the database is encrypted with the operator's public encryption key.)

Data items 1, 5 and 8 are preferably written to by the IODS subsystems illustrated in FIG. 2. Data items 2, 4, 6 and 7 are preferably configured by the resource provider. Data item 1 provides the basic information on which useage-based billing is based. Data item 2 provides the bandwidth on which quality of service (QOS) management is based, as described in detail herein. Data item 3 is written to from the IODS central database and contains the public encryption keys of the integration operator and subscribers who will engage in secure sessions over the network. Data item 4 provides the logical network connection/address for the IODS to enable the NAS to communicate with the IODS over the network. Data item 5 is essentially the same voice billings 3950 information illustrated in FIG. 2 and described in detail herein. Data item 6 provides DHCP configuration from database parameters. Data item 7 provides the IP filter address information for IP filtering to restrict access to the private network.

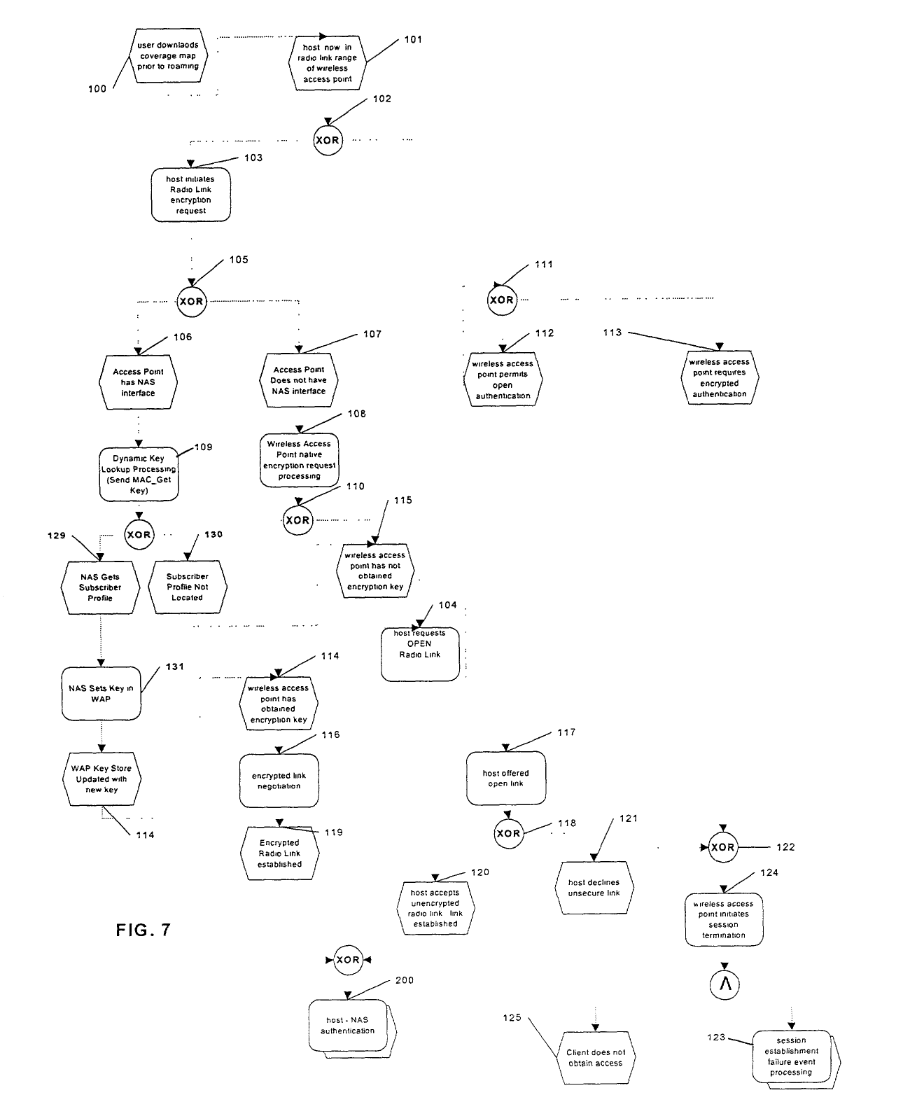

The network access point control services are preferably provided by a wireless access point management interface 36, e.g., a programmatic interface to the WAPs 3, 4. The wireless access point management interface 36 provides an optional interface to enable radio link encryption (link layer encryption) for roaming mobile terminal users. Preferably, this is accomplished using SNMP to programmatically control the WAPs via a programmable API as described herein. The preferred operation of such a subsystem is illustrated in detail in FIG. 7.

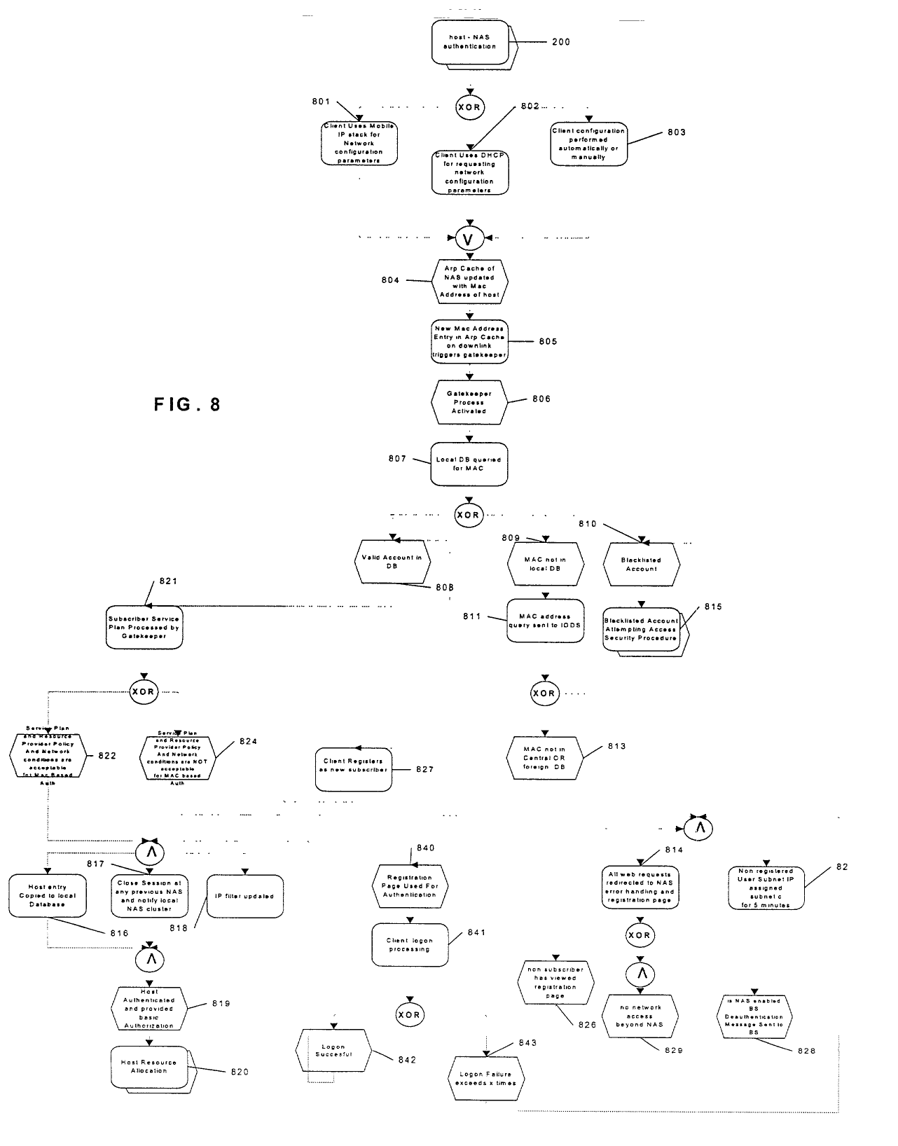

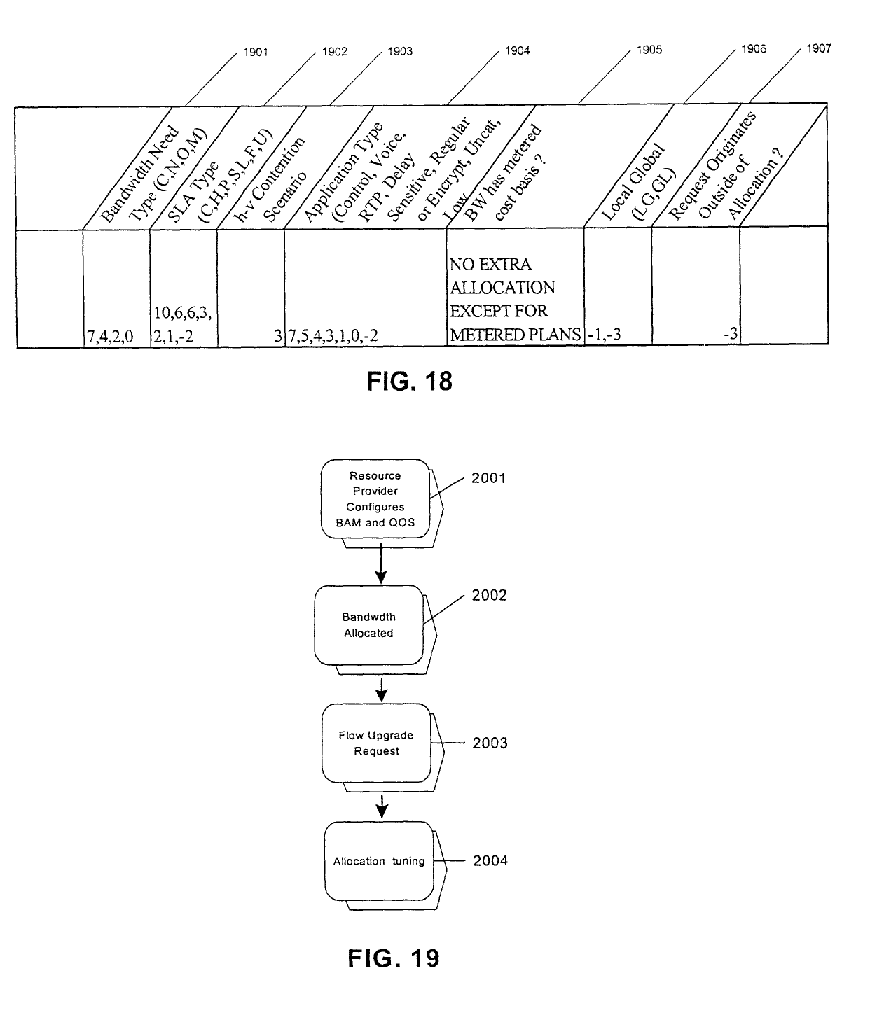

The web services 37 are provided by HTTP and HTTPS servers. The HTTPS server provides a secure sockets layer HTTP server. The HTTPS server has two functions: first to permit the resource provider to administer the NAS, and second to facilitate registration of visiting mobile terminals. These functions are illustrated in detail in FIG. 8. Preferably, the resource provider will access the NAS via the HTTPS server to (1) configure public network access policy, as shown in FIGS. 18-20; (2) configure DHCP scope to configure pool(s) of available IP addresses; (3) modify the firewall and/or IP filter if necessary; and (4) view billing information. With respect to registration, any mobile terminal attempting to gain access to the network and which has not previously registered and been authenticated, will be directed by the NAS to a registration page using the HTTP server.

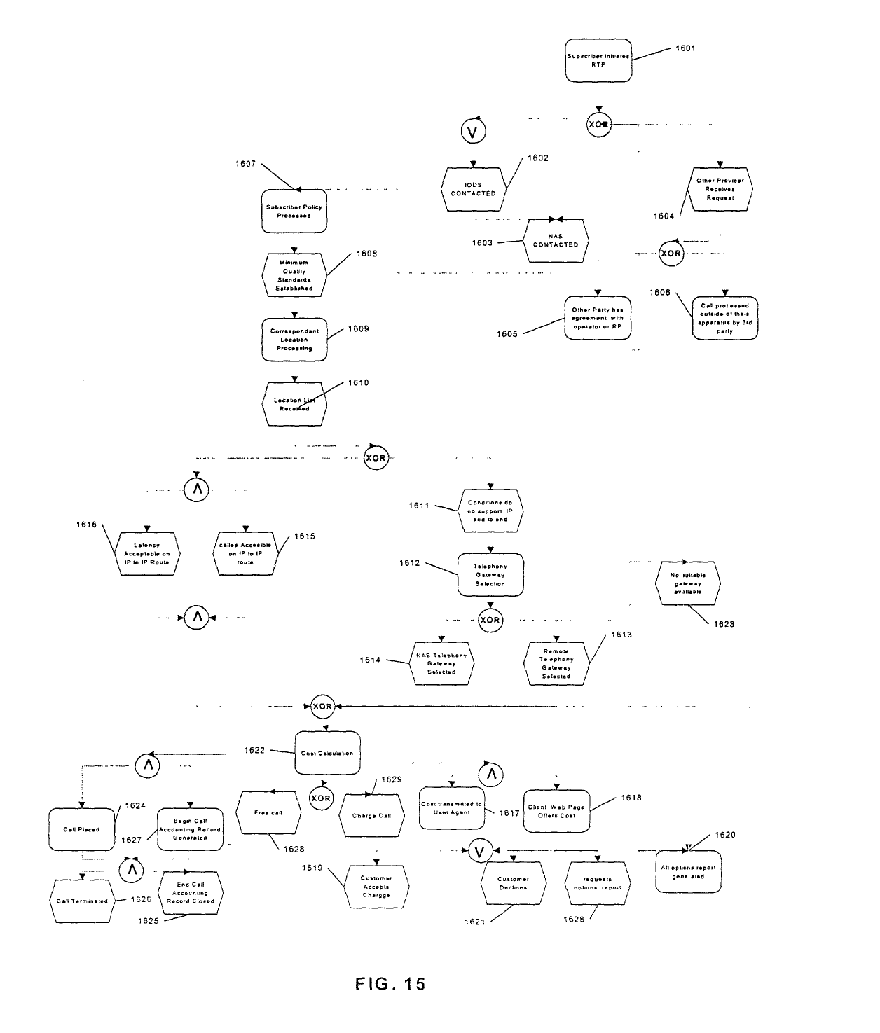

The telephony services are provided by a telephony gateway routing server 35, a local telephony gateway 39, and a telephony call request server 43. The details of realtime communications processing are illustrated in FIGS. 15 and 16. However, generally, the telephony call request server 43 accepts and processes IP telephony requests, e.g., VoIP requests, from mobile terminals. The telephony call request gateway 43 employs the telephony gateway routing server 35 to route IP telephony calls over the network via an appropriate telephony gateway, depending upon cost considerations and network conditions. For example, the server 35 may forward a call for end to end communications over the network using IP routing if the intended correspondent node has IP telephony capability and if network conditions are conducive to voice communications. Alternatively, if the intended correspondent does not have IP telephony capability, the server 35 may dispatch a call to the local telephony gateway 39, a remote telephony gateway, or to the public switched telephone network (PSTN), depending upon cost and prevailing network conditions. Preferably, the server 35 employs standard session initiation protocol (SIP), as published in IETF RFC 2543, together with extensions for interfacing to the PSTN, published as IETF RFC 2848. Alternatively, the server 35 may implement ITU standard H.323, together with a JAIN or PARLAY-compliant Internet/PSTN API. Many IP telephony firms support both SIP and H.323, including Lucent.

The local telephony gateway 39 also preferably has a suitable API, such as Microsoft's telephony API (TAPI), which converts H.323 or other standard telephony signals for transmission over the PSTN, and a PSTN hardware interface card such as a voice modem or multi-port VoIP gateway card. Preferably such devices enable routing calls bidirectionally. A suitable product for this purpose is the Dialogic D/41ESC 4 Port SCSA Voice Processing Board. WebSwitch, available from L.M. Ericsson, may also be suitable.

The NAS′ master controller process is referred to as the gatekeeper 24. Gatekeeper 24 provides central process control for the NAS components, including dispatching control messages to various processes and software components such as IP Filter 26 and the NAS′ local database 45 which, as described herein preferably comprises a subset of the IODS master database shown in FIG. 2, created via LDAP replication (LDUP). Among other functions, gatekeeper 24 preferably receives periodic notifications from ARP 23 that a new MAC address has been received, i.e., a new mobile terminal has established a communication link with a WAP. Gatekeeper then passes that information via the application programming interfaces to other NAS components that perform specific functions, described in detail below. However, if as mentioned previously, ARP 23 is not capable of forwarding MAC addresses to gatekeeper 24, gatekeeper 24 will periodically fetch the contents of the ARP's cache and determine whether any new MAC addresses have been received. Any packets transmitted by mobile terminals having IP addresses not present in either the NAS′ local database 45 or the IODS master database 3000 are preferably processed through the fraud detection processing routine, described herein, then discarded or ignored by the ARP and gatekeeper.

Gatekeeper 24 also preferably manages network quality of service (QoS) functionality. Gatekeeper 24 preferably includes a bandwidth allocation manager (BAM) 28 for this purpose. The BAM essentially acts as a layer between an existing QOS system, many of which are well known, and the gatekeeper to enhance the prioritization capabilities of the existing QOS system. The BAM preferably implements resource provider policies for bandwidth useage and allocation by subscribers and private network clients, including the throttling of bandwidth available to each public access subscriber and private network client. The BAM also preferably handles queuing between public access subscribers, i.e., registered, authenticated mobile terminals, having equal priority for network resources, etc. The BAM may perform these functions by calling the appropriate functions and routines contained in libraries typically available through the operating system's QOS services, such as the generic Quality Of Service libraries available in the Windows Sockets API. Alternatively, a commercial bandwidth manager may be employed. One commercial bandwidth manager is available from Emerging Technologies under the product name Bandwidth Manager. The bandwidth manager may also be based on Cisco System's resource reservation protocol (RSVP) or similar software products, which are readily available from other vendors of remote network access products, or on the IETF's differentiated services standards, DIFFSERV, as published in IETF RFCs 2475, 2983, and related RFCs.

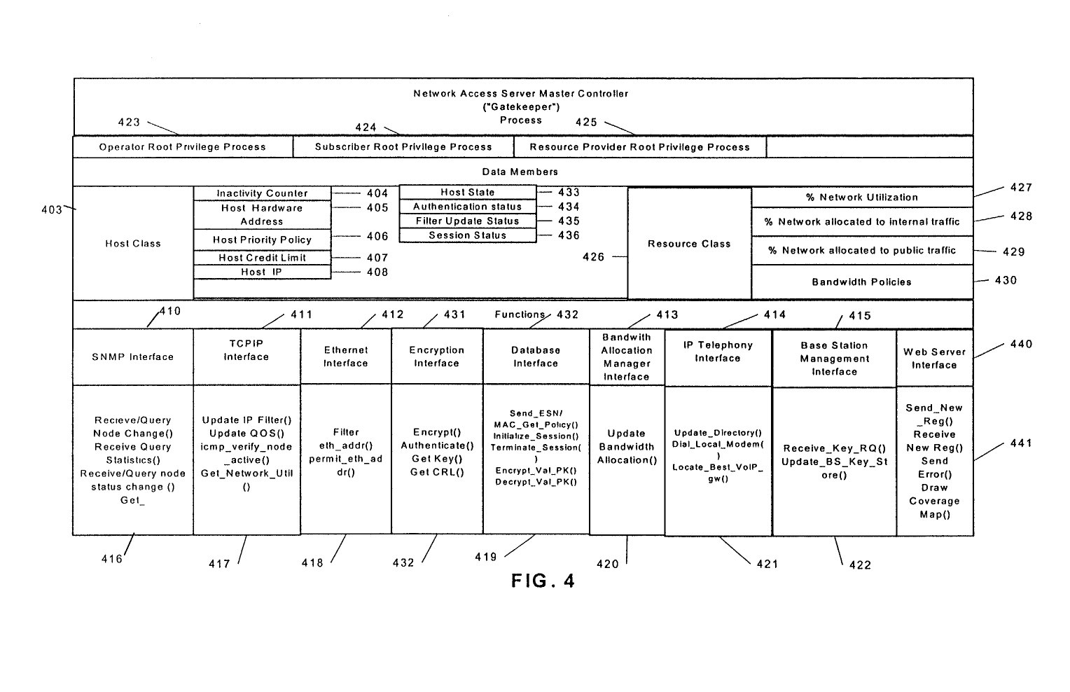

FIG. 4 illustrates in further detail the components and functionality of the preferred gatekeeper 24. As stated, gatekeeper 24 comprises the master controller process for the NAS. It maintains the session state of every detected mobile terminal on the network, monitors uplink resources, and performs related activities. The gatekeeper master controller process operates in three privilege modes: Operator Root Privilege Process Mode 423 (“Operator Mode”), Subscriber Root Privilege Process Mode 424 (“Subscriber Mode”), and Resource Provider Root Privilege Process Mode 425 (“Provider Mode”). For example, to control the bandwidth allocated to visiting mobile terminals, administrative access to the resource provider's uplink port is required. However, since in many cases, for example a corporate network, the resource provider will not want the integration operator to have access to its routing tables or bandwidth allocation facilities, such operations will preferably run in the Provider Mode. Other functions, such as updating billing and accounting information, may not be accessible by the resource provider and therefore will preferably run in Operator Mode. Still other functions may run in Subscriber Mode.

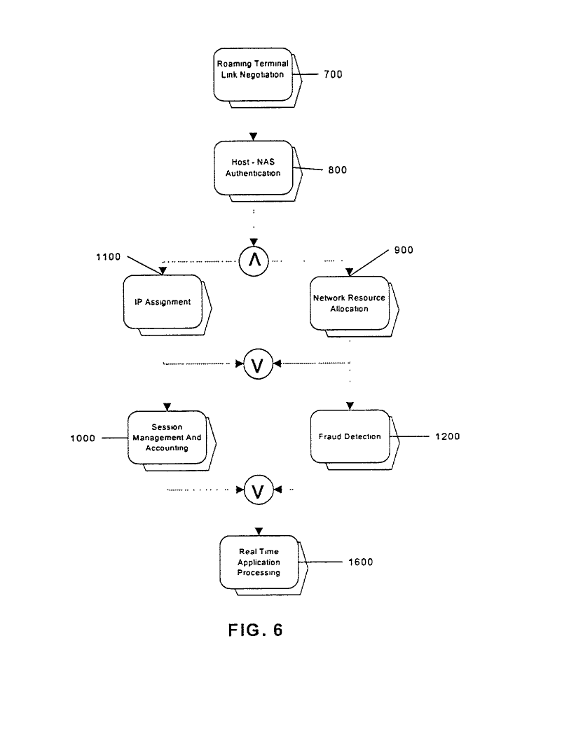

A number of data structures 402 exist within the preferred gatekeeper master controller process. These preferably include the host class data structure 403 and the resource class data structure 426. As used herein, “host” refers to mobile terminals on the network, and the host class data structure 403 maintains data relating to each of the mobile terminals on the network. The host class data structure 403 includes a number of data members corresponding to the state and attributes of each such mobile terminal. These include an inactivity counter 404, a host hardware address 405, a host priority policy 406, a host credit limit 407, a host IP 408, and a host state 433. The host state 433 contains flags for all critical states, such as authentication status 434, filter update status 435, and session status 436. The state of these flags are used to pass control between the various software routines constituting the core gatekeeper functions, as described in detail below in conjunction with FIGS. 6-12. The resource class data structure 426 contains data related to the state and attributes of the resource provider's commodity, i.e., network bandwidth. Thus, the resource class data structure 426 contains data members for the percentage of network bandwidth utilized 427, the percentage of network bandwidth allocated to internal or private network traffic 428, the percentage of network bandwidth allocated to public or subscriber traffic 429, and bandwidth allocation policies 430, which essentially mirror the bandwidth policy information of policy table 3650 of the IODS master database 3000 of FIG. 2.

The gatekeeper 24 also preferably comprises a number of functional components 409, which initiate, maintain, modify, process, and terminate host sessions. The gatekeeper preferably includes function 416, which implements calls to other NAS subsystems and components via an SNMP interface 410, function 417 for calling the TCP/IP stack in the operating system kernel via a TCP/IP interface protocol 411, such as a sockets function available from a number of vendors, and function 418 for calling the network layer 2 driver, e.g., NDIS, via an Ethernet Interface 412. The gatekeeper also preferably includes function 432 for handling data encryption and decryption, as well as public key operation, via an encryption interface 431, such as the generic security system application program interface (GSS-API), function 419 for calling the NAS local database using a database interface 432, such as an LDAP API, function 420 for managing network QOS 413 via the BAM, function 421 for calling IP telephony services using an IP telephony interface 414, such as TAPI and SIP API's, and function 422 for managing WAPs via a base station management interface 415 such as the SET function of SNMP. the gatekeeper also preferably includes function 441 for communicating registration and related data with the http/https server via a web server interface 440.

FIGS. 17-19 illustrate the details of the BAM 28 and QOS functionality 413 it provides. In general, a number of QOS systems are already in use. However, these tend to be end-to-end systems in which each hop in a network is known to implement the same QOS system. In the present invention, since the NAS and IODS connect over the Internet, it cannot be assumed that each hop will implement the same QOS or any QOS at all for that matter. Moreover, to implement existing QOS between a host and router, both host and router would have to be QOS enabled. The present invention, however, seeks to provide QOS functionality and support for roaming mobile terminal network nodes that may or may not be QOS enabled, and regardless of their operator specific software and hardware. The QOS functionality of the present invention therefore as implemented by the BAM is designed to supplement and cooperate with any existing end-to-end QOS systems that may be in place, such as RSVP or one based on the IETF DIFFSERV standards, or to function alone if no such system is in place.

Throughout the following description, reference will be made to flows or packet flows. A flow or packet flow in this description means a flow or stream of IP-based packets from a source IP address and port to a destination IP address and port using a particular network protocol, such as TCP. The present invention relies upon TCP in conjunction with QOS application level software to detect network congestion and to adjust the rate of transmissions, i.e., the packet flow rate, on the port or ports most likely to suffer from congestion. Preferably, the BAM achieves programmatic control of such ports either by interfacing through an existing QOS system in control of the ports, if available, or through an existing QOS protocol. In the exemplary embodiment described herein, the network points most likely to suffer significant congestion happen to be the network links into and out of the NAS. Thus, the QOS functionality implemented by the BAM is preferably designed to be specific to the NAS node of the network. Still more specifically, the QOS functionality of the BAM is preferably designed to specifically apply to the NAS′ public network uplink bandwidth. It is not necessary for the BAM to explicitly control allocation of the NAS′ downlink bandwidth because the normal behavior of most session oriented network protocols, such as TCP and RTP over UDP will produce a nearly equivalent degree of bandwidth on the NAS′ downlink, once the uplink is appropriately throttled.

The BAM preferably allocates the available bandwidth of the NAS′ uplink between private network useage and public access useage. The resource provider preferably assigns a threshold utilization rate to the NAS′ uplink based on its reported and observed bandwidth, the expected number of private network and public access users, and the portion of available bandwidth allocated to each, as described herein. When the uplink utilization exceeds the threshold, as determined and reported by TCP, an event is generated, preferably via SNMP, and is preferably logged to both the resource provider and the IODS. In response to the generation of the event, the BAM, through the gatekeeper 24 prevents further public access sharing of the uplink until the public utilization rate falls below the threshold for a predetermined period of time. This time can be shortened or lengthened by the resource provider depending upon experience with the frequency and length of time the threshold is exceeded. The resource provider may also reallocate bandwidth between private network and public access users as appropriate or desired.

The BAM preferably also allocates a portion of the NAS′ available uplink bandwidth to each network user up to a selected maximum number of concurrent users. When less than the maximum number of users is connected to the network, the BAM allocates each of them a portion of the NAS′ available uplink bandwidth to execute applications, etc. As additional users connect to the network, the BAM decrements each user's bandwidth allocation. Different users may be assigned different bandwidth allocations depending upon whether they are public access subscribers only, or clients of the private network. Different allocations may also be based upon subscribers' access plans or other considerations of importance to the resource provider. As shown in FIG. 17, the BAM sets a minimum user bandwidth allocation 1801, which is modifiable by the resource provider. When all user bandwidth allocations are utilized, the BAM notifies the gatekeeper 24, which prevents new users from being permitted to connect to the network. An exception is if an existing user has its allocation reduced or is disconnected based on losing priority to their bandwidth allocation.

Starting with the baseline bandwidth allocations to each network user, the BAM employs a conventional applications definition list 1802 as input to further manage the bandwidth allocations. The applications definition list 1802 contains a set of criteria that characterizes flows of packets over the network. Preferably, the BAM employs a classification system that is consistent with the classification criteria employed in existing end-to-end QOS systems. In the embodiment illustrated in FIG. 17, for example, packet flows are classified broadly as control traffic 1804, voice 1805, real-time 1806, delay sensitive 1807, standard 1808, delay insensitive 1809, unclassified 1829, and low priority 1830. The BAM may suitably obtain the applications definition list 1802 information by accessing the list of an existing end-to-end QOS system already in place, such as RSVP or one based on the IETF DIFFSERV standards, through a programming interface 1821. Alternatively, the BAM may parse the type of service (TOS) field contained in the IP header of packets received by the NAS, extract the information, and create and maintain its own applications definition list. Also alternatively, the integration operator may maintain an internal applications definition list applicable to the NAS, and may periodically replicate it to the NAS′ local database.

Each application type is assigned a minimum required bandwidth 1810, a normal required bandwidth 1812, an optimized bandwidth 1813, and a maximum bandwidth 1814. It is a primary function of the BAM to ensure that at least the minimum network bandwidth resources are available for each application. If sufficient excess bandwidth remains available after each application has been allocated its minimum required bandwidth, the BAM attempts to allocate normal bandwidths 1812 to the applications. If excess bandwidth still remains available, the BAM attempts to allocate optimized bandwidth to each application. If excess bandwidth still remains available, the BAM attempts to allocate maximum bandwidth to those applications optimized for bursty traffic, which is usually delay insensitive applications such as email. Finally, if excess bandwidth still remains, the BAM attempts to allocate maximum bandwidth to other applications. Thus, preferably each flow of packets, i.e., each application, is assigned to one of four bandwidth levels minimum, standard, optimized, or maximum, depending on the total bandwidth available. Preferably, the BAM promotes applications from one bandwidth level to the next, and demotes applications from one bandwidth level to the next, in a quantized fashion, rather than incrementally.

Applications are preferably promoted and demoted between bandwidth levels based on a user priority and weighting scheme described herein. A service level agreement priority list identifies various categories of network users. In the preferred embodiment, the categories of users are identified as control users 1828, home or local users 1816, priority users 1817, standard users 1818, discount users 1819, free users 1820, and unregistered users 1831. Examples of control users are the NAS itself, the IODS network gateway, a router associated with the NAS, and other network infrastructure devices and control sessions with such devices. Hone or local users are typically users who are clients of the service provider's private network or organization rather than roaming public access subscribers. Such users are preferably given a very high priority compared to other network users. Priority users are public access subscribers who pay a premium for additional bandwidth, when available, to ensure packets will not be dropped. These users also are given very high priority relative to other users. Standard users are normal public access subscribers. Discount users are public access subscribers who accept a lower priority in exchange for lower cost access. Free users are special access users. Such users are normally not given access to the network, except in connection with special programs, such as university or conference programs, or the like. Unregistered users are those users who are not authorized to access the network. Although unregistered users could be given network access if desired, it is not preferred.

As stated above, the BAM interfaces to an existing end-to-end QOS system, if any, via a QOS system interface 1821. Various QOS schemes are presently in existence, including Multi-Protocol Label Switching (MPLS) 1822, Subnet Bandwidth Manager (SBM) 1823, IETF Differentiated Services (DIFFSERV) 1824, COPS 1825, ReSerVation Protocol (RSVP) (IETF RFC 2205) 1826, and Asynchronous Transfer Mode (ATM) 1827. Preferably, the interface 1821 is implemented so as to avoid duplication and to operate similarly with any of these schemes to provide substantially similar QOS conditions at the NAS uplink regardless of which end-to-end QOS scheme is in place.

FIG. 18 illustrates an exemplary way in which a resource provider can parameterize and weight the various bandwidth, user, application, and other parameters to determine the bandwidth level which will be allocated to applications. Essentially, in the preferred embodiment, each parameter is assigned a weight by the resource provider. The weights of the various parameters corresponding to an application are summed, and the weighted sum determines which level of bandwidth the application will be allocated. Preferably, the weighting values are assigned to tune the QOS system such that all applications tend to run at their minimum bandwidth level.

In the preferred embodiment, the parameters include bandwidth need type 1901, service level agreement or user priority type 1902, a home versus visiting user preference 1903, application type 1904, a bandwidth metered cost basis parameter 1905, a local global contention parameter 1906, and a flow request origination parameter 1907. The bandwidth need types 1901 include critical or minimum bandwidth level (C), normal or standard bandwidth level (N), optimized bandwidth level (O), and maximum bandwidth level (M). In the particular example shown in FIG. 18, these parameters are assigned weights of 7, 4, 2, and 0 respectively. Thus, this QOS implementation is tuned such that an application requesting allocation of its minimum bandwidth level necessary to run is assigned a significantly higher weight than one requesting its maximum bandwidth level. Similarly, service level agreement or user priority types 1902 include control user (C), home or local user (H), priority user (P), standard user (S), discount user (L), free user (F), and unregistered user (U). Here, the resource provider has assigned weights of 10, 6, 6, 3, 2, 1, and −2 respectively to each of the user priority types. The home-visitor preference parameter 1903 comes into play when a user requests allocation of bandwidth over and above their own allocation, and the additional allocation requires decrementing the allocation of another user. The user from whom bandwidth is to be taken, i.e. the user with the application having the lowest weight, is assigned some weighting factor, in this case a weight of 3. This additional weight preferably ensures that additional bandwidth allocations will not be given to users having applications of substantially the same weight at the expense of other users, but only where an application has substantially greater weight than one from bandwidth is to be deallocated. Application types 1904 preferably include control, voice, real time protocol (RTP), delay sensitive, regular or standard, delay insensitive, unclassified or uncategorized, and low priority. In this example, these application types are assigned weights of 7, 5, 4, 3, 1, 1, 0, and −2, reflecting the relative importance of each receiving higher levels of bandwidth allocation. The bandwidth metered cost basis parameter 1905 reflects the situation where the bandwidth is based on a metered useage cost. In that instance, in this example, no application is given any weight toward extra bandwidth allocation except applications being run by users on metered useage plans. The local global contention parameter 1906 provides a preference between private network clients (local users) and public access subscribers (global users) when the resource provider has partitioned uplink bandwidth between public access use and private network client use. In that case, in this example, if a local user is attempting to encroach on bandwidth allocated to the global users, a weight of −1 is assigned, whereas if a global user attempts to encroach on bandwidth allocated to local users, a relatively heavier penalty of −3 is assigned. The flow request origination parameter 1907 comes into play if a user requests bandwidth allocation for an application when the user is already over the user's assigned bandwidth allocation. For example, if a user having a 100 kbps bandwidth allocation is running a voice application allocated 70 kbps and a web browser allocated 32 kbps, and then attempts to conduct a file transfer over the network, the request for additional bandwidth for the file transfer application originates at a total bandwidth that is already over the user's bandwidth allocation. In that instance, in this example, the user's request for additional bandwidth is assigned a penalty weighting of −3.

The present example is based on a weighted sum approach. Other approaches for determining the relative importance of various QOS-related parameters are also acceptable, provided they enable suitable tuning of the QOS system by the resource provider and do not conflict with any existing end-to-end QOS system(s) already in place. For example, a nested parameter approach could be used in place of the weighted sum approach described. In the nested parameter approach, the resource provider would simply determine the order of the flow classification parameters within a nested selection statement, such as (1) public or private, (2) delay sensitive or delay insensitive, (3) individual user or reserved flow, (4) service plan. In this approach following each path down the chain would result in the assignment of a bandwidth allocation value. Different paths, i.e., different combinations of classification parameters thereby result in different bandwidth allocation values being assigned relative to each other.

FIG. 19 generally illustrates the overall setup and operation of the BAM and the QOS system. Regardless of which approach is used to assign values to the various classification parameters, the resource provider preferably reviews the historical statistics concerning network useage, determines the total available bandwidth to be allocated, and estimates the number of users amongst whom the available bandwidth is to be allocated. The resource provider then preferably establishes bandwidth allocation policies based on the offered service plans, the degree of protection to be given individual users, a determination whether to prioritize private network originating traffic or public access revenue traffic, and the need to provide at least minimal QOS for delay sensitive applications such as VoIP. Based on these policies and determinations, the resource provider preferably establishes the weights to be assigned the various parameters or the values to be assigned the various branches in the nested chain and configures the BAM and QOS 2001. As each user connects to the network he is initially assigned a base bandwidth allocation 2002. As users execute applications over the network, flow upgrade requests are sent to and processed by the BAM and QOS 2003. And, as applications execute and complete, packet flows are created and destroyed. As the packet flows are created and destroyed, the actual bandwidth allocation to each user is altered and tuned by the BAM and QOS 2004, based on the values assigned to the classification parameters, and the values assigned by the resource provider to each bandwidth allocation level 1810-1814. The BAM constantly attempts to upgrade packet flows to their maximum bandwidth allocations, and constantly tunes the each packet flow to achieve maximum efficiency of transfers and reliable and smooth functioning of each flow. Those skilled in the art will recognize that even though the bandwidth allocations at any given time will be changing dynamically, the base bandwidth allocations preferably provide a baseline or metric for the system and remain the same unless and until changed by the resource provider by reconfiguring the BAM and QOS.

FIG. 15 illustrates the details of the real time processing/telephony services of the NAS, as shown in FIG. 3. A mobile terminal visiting the network may be equipped with an agent for IP telephony or video conferencing. Many such agents exist today, including for example, the Session Initiation Protocol (SIP), published as IETF RFC 2543, with its extensions for PSTN access, entitled “PSTN/Internetworking (PINT) Service,” published as IETF RFC 2848. ITU standard H.323 provides similar functionality, and JAIN and PARLAY provide additional telephony/Internet integration services. Many IP telephony firms, such as Lucent Technologies, support both SIP and H.323. The following description assumes the NAS and IODS support at least the SIP standard and its extensions.

A mobile terminal initiates a real time conferencing session in step 1601. Upon initiation, the mobile terminal's real time conferencing agent obtains the address of a suitable real time conferencing/telephony server parameter. This can be accomplished in a number of different ways. The mobile terminal may obtain the address from DHCP, if available (see Internet Engineering Task Force SIP Work Group Internet Draft “draft-ietf-sip-dhcp-03.txt” at http://ietf.org, by G. Nair and H. Schulzrinne of Columbia University, published Jan. 20, 2001, entitled “DHCP Option for SIP Servers”). Alternatively, the mobile terminal may obtain the address from the Service Location Protocol (IETF RFC 2608). Another alternative is that the mobile terminal may manually configure the telephony server's address internally. Still further, the mobile terminal may query DNS for the addresses of appropriate real time conferencing/telephony servers.

If the mobile terminal obtains the telephony server's address dynamically, the mobile terminal's query will be forwarded to the telephony call request server 43 of the NAS as shown in step 1603. If the mobile terminal maintains a static server address configuration internally, the mobile terminal's agent will connect to that server, which may be either a third party vendor's real time conferencing/telephony server as shown in step 1604, or the [ODS as shown in step 1602, depending on the mobile terminal's internal address configuration. In the event the IODS is contacted, it forwards the mobile terminal's request to the telephony call request server 43 of the NAS, as shown in step 1603.

If the third party vendor has a service agreement with the integration operator or the resource provider (or both), as shown in step 1605, the third party vendor will forward the mobile terminal's request either directly to the NAS or indirectly to the NAS by way of the IODS, as shown in steps 1605, 1603, and 1602. The mobile terminal's request and connection will then be managed by the NAS. However, if the third party vendor does not have a service agreement with either the integration operator or the resource provider, the vendor will process the connection and neither the NAS, nor the IODS will be involved, as shown in step 1606.

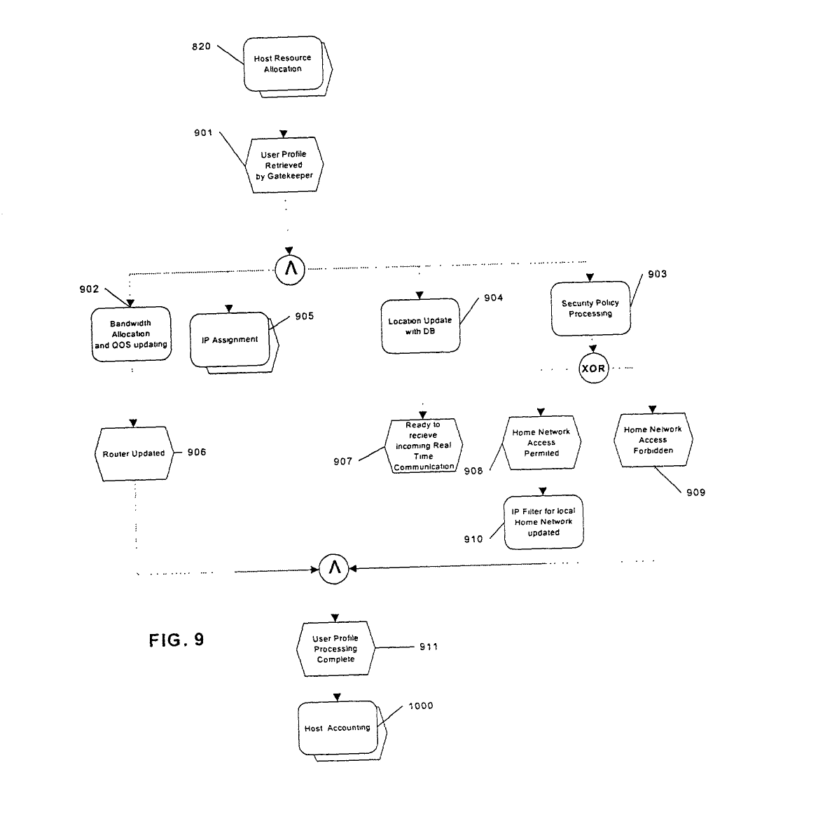

Upon receipt of the mobile terminal's request, the telephony call request server 43 of the NAS retrieves the applicable subscriber policy information from the NAS′ local database, as shown in step 1607. This information is retrieved from the IODS master database to the NAS′ local database when the NAS′ gatekeeper component processes the user's profile information as part of the user connecting to the network, as shown in FIG. 9. Unless the user has specifically customized the conferencing parameters (consisting of quality versus cost), the NAS will determine a set of latency and cost metrics from the subscriber's service agreement. For example, if the subscriber has a high priority service agreement, cost will be considered after quality, whereas if the subscriber has a discount (low QOS) agreement, then cost will have a heavier weighting than latency. The mobile terminal can bypass the automatic weighting by connecting to the NAS web server directly, as shown in step 1618.

The NAS′ telephony call request server 43 also determines the minimum quality standards for the requested real time conferencing from the subscriber agreement as shown in step 1608. This information is stored in the IODS and a subset thereof replicated in the resource provider's local database. The minimum quality standards are used by the telephony call request server 43 to determine whether the call or other real time conferencing request can be routed over the IP network end to end, or whether it should be routed via a telephony gateway, or directly to the PSTN from the resource provider's network.

The telephony call request server next contacts the NAS directory agent 34 to obtain a list of addresses for the correspondent the mobile terminal wishes to communicate with, as shown in steps 1609 and 1610. Once the telephony call request server has the IP addresses for the correspondent node, it proceeds to measure the latency to each IP address over the IP network. It preferably does this by sending four ICMP packets to each correspondent IP address and measuring the roundtrip latency. If the latency for any address falls within the minimum quality standard requirement and the IP address is in fact reachable over the network, as determined in steps 1615 and 1616, the server retrieves any applicable cost information from the resource provider's local database, as shown in step 1622. The resource provider might for example apply a surcharge of two cents per minute to IP telephony calls routed over its network. If applicable cost information is not available in the resource provider's local database, the NAS obtains any applicable cost information from the IODS master database.

If the call or real time conferencing request cannot be placed via IP routing, as determined in step 1611, then the telephony call request server 43 invokes the telephony gateway routing server 35 of the NAS to select an appropriate telephony gateway to make the connection, as shown in step 1612. The telephony gateway routing server 35 offers the call to the lowest latency PSTN gateway having the lowest cost using conventional routing algorithms. If the NAS is equipped with a local NAS telephony gateway 39, and if the local NAS telephony gateway 39 has the best combination of cost and latency, the telephony gateway routing server connects the call or conferencing request through the local telephony gateway 39, as shown in step 1614. However, if a remote telephony gateway has a better combination of cost and latency, the telephony gateway routing server will connect the call or conferencing request through the remote telephony gateway having the best combination available, as shown in step 1613. If no telephony gateway having a combination of latency and cost satisfying the minimum quality requirements is available, as determined in step 1623, the telephony gateway routing server reports the available options to the caller, including the latency and cost associated with each route, as shown in steps 1620, 1622, and 1629. The caller may then decline to place the call or request, or may accept one of the options offered, as shown in step 1619.

Once the optimal route is determined, or the customer has selected a particular route, the NAS performs a cost calculation as shown in step 1622. If the NAS determines there is no cost and that the call is free, as shown in step 1628, the call is placed directly and an accounting record is generated, as shown in steps 1624 and 1627. If the NAS determines the call is a charge call in step 1629, the NAS transmits the estimated calculated cost to the mobile terminal telephony client software in step 1617, and updates the cost information on the client web page in step 1618. This is done in the event the mobile terminal telephony agent software is unable to process the cost information received from the NAS. In that event, the mobile terminal user can connect directly to the web page and obtain the cost information. The mobile terminal user can also request a report of all routing options in step 1628, in which case every possible routing option will be reported regardless of cost and latency. If the mobile terminal user declines to connect the call or request via any option in step 1621, the process terminates. If, however, the mobile terminal user accepts the estimated cost, obtained either directly from the NAS, or from the web page, as shown in step 1619, the call is placed and an accounting record generated as shown in steps 1624 and 1627.

When the call terminates, as shown in step 1626, an end call accounting record is generated in step 1625. The NAS stores the accounting information in its local database for eventual billing of the user. The NAS also updates the corresponding voice accounting information in the IODS master database eventually.

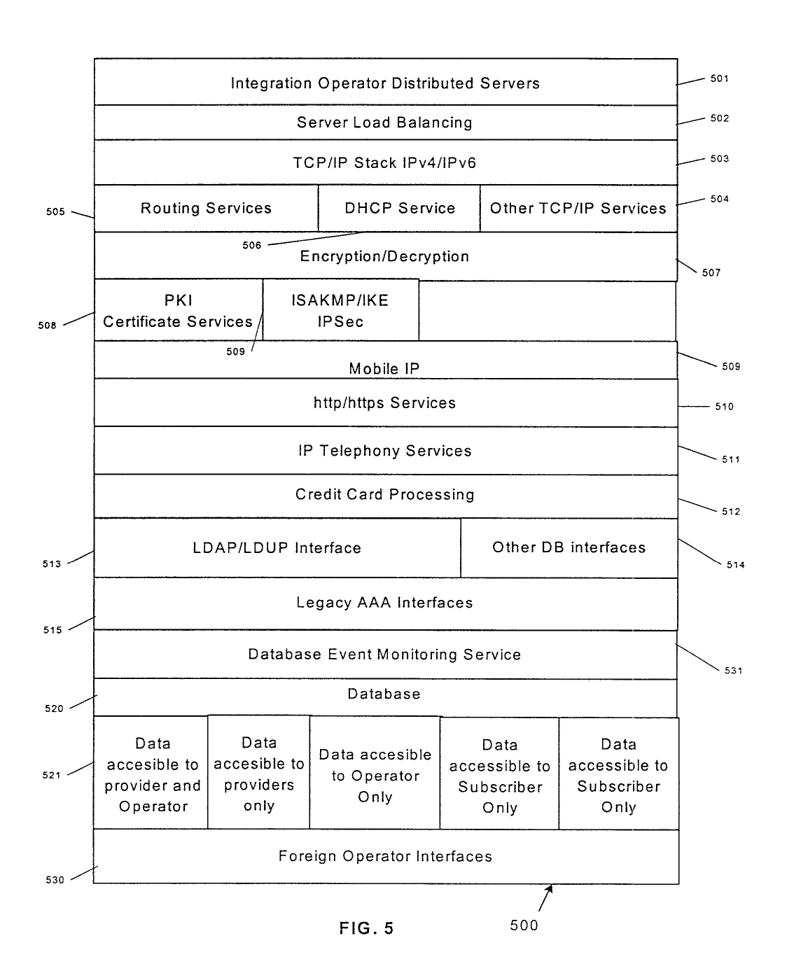

Referring to FIGS. 2 and 5, the preferred embodiment of the IODS 18 will now be described in greater detail. The IODS 18 generally comprises a database 3000 and a number of functional service components 500. While database 3000 may be implemented as a central database on a single or small number of connected servers, it is preferred that the database 3000 be implemented in a distributed arrangement spread over a number of servers. For example, the database elements might be distributed among a system of servers placed strategically in a variety of Internet exchanges and central offices and linked by routers. A distributed scheme offers advantages related to scalability, among others. Distributed server systems and database arrangements suitable for this purpose are well known to those skilled in the art and need not be described in detail herein.

As shown in FIG. 2, the IODS database 3000 is logically hierarchical in nature and in the preferred embodiment comprises three layers or levels. The top layer 3010 relates to identifying information for users (subscribers), resource providers, and integration operators. The second level 3020 relates to various network objects and policies, and is logically linked to the first level subscriber and resource provider information. The third level 3030 relates to network events, transactions, and status, and is linked to the second level by the relationship between the status and associated network object (network component).

The first level 3010 preferably includes a subscriber table 3100, a resource provider table 3200, and one or more operator tables 3300. As used herein “table” is not intended necessarily to refer only to a flat file or list, but may also refer to a relational database or database segment as well. The subscriber table 3100 preferably contains information about each user who has been previously registered and who is authorized to access the network, i.e., a subscriber. Such information preferably includes name and contact information, form of payment information if desired or appropriate, such as credit card or invoice, credit card data if appropriate, and corporate credit account information, such as whether to invoice an account or bill to a credit card.

The resource provider table 3200 preferably contains information about the entity providing the network resources permitting subscribers to access the public network. Basic information preferably included in this table are the name and contact information for the resource provider.

The integration operator table 3300 is essentially identical to the resource provider table 3200, since integration operators are considered resource providers as well. The major difference is that the integration operators provide wireless access, as well as network infrastructure and services, settlement, security, and support.

The second level 3020 preferably includes an adapter table 3400, a policy table 3500, a resource object table 3600, and a resource provider public access bandwidth policy table 3650. The adapter table 3400 preferably includes information identifying the equipment ID's, e.g., the network layer 2 MAC addresses, for each previously authorized mobile terminal of each registered subscriber, and an access plan designation for each. The adapter table 3400 is logically linked to the subscriber information in the first level 3010. Each equipment address, i.e., mobile terminal, can have its own access plan, and conversely a single plan can cover multiple equipment addresses. Preferably, the adapter table 3400 further identifies the security policies for each mobile terminal, linked to the mobile terminal's equipment address, and optionally a set of layer 2 cryptographic keys for use in encrypted communications with the mobile terminal, if available. There are several potentially applicable security policies. One policy applies to communications between the mobile terminals and the WAPS. Under this policy, if network layer 2 encrypted communications are not possible, for example because the manufacturer of the mobile terminal and the manufacturer of the WAPS have implemented incompatible encryption schemes, then layer 2 encryption is turned off and the mobile terminal communicates with the WAPs in an open session. A second policy is directed to communications between the NAS and the IODS. If in effect, this policy specifies to create a secure tunnel for communications between the NAS and the IODS. There are numerous algorithms for determining when and for which communications such a secure tunnel should be used, and the selection of one or more depends upon the needs of the specific system. However, if this policy is in effect, use of such a communications control algorithm is preferred over merely routing all communications through the tunnel in order to avoid potentially severe latency problems. A third policy relates to employing layer 3 IPSec encryption for communications between the mobile terminals and the NAS. If in effect, this policy provides for security of the wireless link only, which is the most vulnerable segment of the network for eavesdropping. However, layer 3 encrypted communications incur some additional overhead which can result in performance limitations. A fourth policy is to enable standard security only. In that case, all communications will be unencrypted, which is presently the case with most Internet access. A fifth policy applies if a programmatic interface between the WAPs and the NAS is available. For example, if the WAPs have an API which the NAS can programmatically access and thereby command the WAPs, then an additional security option (level 2 link layer encryption) can be offered. If this is available, an encryption key is communicated from the mobile terminal to the WAP and is forwarded from the WAP to the NAS for processing. If the NAS′ local database (LDAP 38, FIG. 3) does not contain an entry with the key, it is forwarded to the IODS to check against the cryptographic keys contained in the adapter table 3400. If no match is detected, then the key is unknown to the network and no layer 2 encrypted communications are possible using the key. The NAS redirects the mobile terminal to a registration page. However, if a match for the key is detected in either the local NAS or remote IODS database, the corresponding encryption information is sent by the NAS to the WAP to enable encrypted layer 2 communications between the WAP and the mobile terminal.

These policies are decided by each resource provider and each subscriber, preferably based on a list of compatibility recommendations published by the integration operator. Thus, for any given mobile terminal device and each software revision level., the integration operator will preferably publish a recommended security mode. For example, a mobile terminal may have problems connecting with a particular WAP when in the “Request Encryption But Permit Open Session” mode. As a result, the subscriber will preferably be advised to configure the mobile terminal for “Open Mode” when on the road, while the mobile terminal may operate quite well in dual mode when at home interfacing to a particular base station having a particular firmware revision level.

Additionally, the adapter table 3400 preferably provides a lost or stolen flag to indicate if a particular mobile terminal having a particular equipment address has been reported lost or stolen. When such a mobile terminal attempts to gain access to the network, appropriate remedial or reporting action can take place.

The policy table 3500 preferably provides information relating to various account details and the availability and details of service plans and is logically linked to the subscriber information in the first level 3010. Available service plans could include a useage based or flat fee plan, a useage or flat-fee based plan with a premium paid for priority access to bandwidth resources over standard users/subscribers, or a free access plan. Priority access plans can be given priority network and/or bandwidth access over non-priority plans. ]Free access plans are an additional option for special circumstances, such as to provide network access accounts to universities or to programs assisting economically disadvantaged persons.

The resource object table 3600 is logically linked to the resource provider information in the first level 3010. Preferably, the resource object table identifies an IP address range available to the resource provider, including IP address sub-ranges and locations for obtaining DHCP IP address allocations. The resource object table also preferably includes a list of the equipment addresses of all registered subscribers and a set of cryptographic keys to enable encrypted communications between the network and the subscribers.

The resource provider public access bandwidth policy table 3650 is logically linked to the resource provider information in the first level 3010. The resource provider public bandwidth access policy table 3650 preferably includes the provider's public access bandwidth policy information. This could include identifying or defining priority traffic, normal traffic, and free traffic, and setting a maximum public bandwidth useage limit, as described in detail in connection with BAM 28.

The third level 3030 preferably contains an adapter state table 3700, session records table 3750, subscriber account status table 3800, and voice billings table 3950, which are all logically linked to the subscriber information in the first 3010 and second 3020 levels. The third level also preferably contains a resource provider account status table 3850 and a resource state table 3900, which are logically linked to the resource provider information in the first 3010 and second 3020 levels.

The adapter state table 3700 preferably contains for each mobile terminal a set of encryption keys specific to the mobile terminal, the identity of the registered owner of the mobile terminal, the identity of the protocol(s) the mobile terminal supports, and the security policy applicable to the mobile terminal.

The session records table 3750 preferably contains information relating to the subscriber's use of the network to enable calculating charges to the subscriber for billing and accounting purposes. Preferably, each record of the session records table 3750 includes an adapter identification, i.e., the equipment address of a registered mobile terminal, the starting time of a session involving that terminal, the equipment address of a correspondent mobile terminal (if any), the number of bits sent and received during the session, and a location identifier, i.e., resource provider identification. The location identifier is the geographical location of the WAP, which is entered by the resource provider when publishing WAP′ resources available to public access subscribers. The correspondent node address assists the subscriber in auditing his bill and is collected as part of the network statistics and stored I the session record periodically, for example every sixty seconds. This session information may be encrypted with the subscriber's public key so that the subscriber will have confidence he can audit his bill without his site visits being surreptitiously recorded. This information can be queried using conventional database querying software to provide summary reports of useage by each registered subscriber.

Similarly, the voice billings table 3950 preferably includes information relating to the subscriber's useage of voice communications facilities of the network to enable calculating charges to the subscriber for billing and accounting purposes. Each record of the voice billings table 3950 preferably includes an adapter identification, i.e., the equipment address of a registered mobile terminal, the starting time of a session involving the terminal, the location of the terminal, i.e., an identification of the resource provider, the phone number called, the amount of time of the session, and the cost per minute or increment thereof. This information can be queried using conventional database querying software to provide summary reports of useage by each registered subscriber, and to calculate charges for useage based plans.

The subscriber account status table 3800 preferably includes subscriber payment history information including, for example, previous payments made by the subscriber, previous charges billed to the subscriber, the subscriber's current account balance, the subscriber's billing cycle, and the number of bits transmitted and received by the subscriber over the network in the current billing cycle. The latter information can be the basis for charging the subscriber under a useage based network access plan.

The resource provider account status table 3850 is similar to the subscriber account status table 3800 in its purpose and the information it preferably contains. The major difference is that the resource provider account status table 3850 preferably provides information that enables settlement of accounts between the resource provider and the integration operator, whereas the subscriber account history table 3800 provides for the settlement of accounts between the resource provider and subscribers. Thus, the resource provider account status table 3850 preferably includes the total number of bits received and sent by public network access subscribers over the current billing cycle using the resource provider's public network access facilities. This information is preferably derived from the information contained in the sessions record table 3750. The table also preferably includes an identification of the accounting or billing cycle between the resource provider and the integration operator. Finally, the table also preferably includes records of previous payments made to the resource provider by the integration operator, and previous credits issued by the resource provider to the integration operator. Account balance may also be included as a data field or as a calculated field if desired.

The resource state table 3900 preferably includes the operational status of each piece of network equipment, its current availability, and its utilization/capacity ratio.

In addition to the data elements and structures identified and illustrated in FIG. 2, those skilled in the art will appreciate that additional data structures and elements are necessary to support Mobile IP, DHCP, SIP, DNS, and IPSec communications when configuring a wireless access network, such as that described herein. However, since these structures and elements are conventional and well known to those skilled in the art of wireless communication networks, it is unnecessary to describe them in detail herein.

As described previously, those components of the IODS most frequently used at the NAS level are preferably replicated to the NAS, using caching and distribution mechanisms well known to those skilled in the art. For example, the well known “LDAP Replication Architecture” (LDUP), identified more fully below, may be used for this purpose. Also, as described previously, the IODS database is preferably updated periodically with new information obtained by its corresponding NAS′. The replication and updating of the IODS database are preferably carried out using the published IETF LDAP Duplication/Replication/Update Protocols. These protocols are published under the title “LDAP Replication Architecture” and can be found in http://www.ietf.org/internetdrafts/draft-ietf-ldup-model-05.txt. Those skilled in the art will realize that LDAP forms the basis of a directory service and is highly compatible with public key encrypted communications and with interoperability between disparate networks. For those reasons, it is considered a suitable mechanism for propagating the IODS database 3000 over the network between the IODS and various NAS′. However, those skilled in the art will also be aware that the facilities provided by LDAP for updating/replication databases may not be as flexible or as efficient as a dedicated network database management tool. Therefore, an alternative approach considered suitable is to partition the IODS database into its transactional elements and directory services elements, and employ a suitable network database management tool to update and replicate the IODS database over the network. Such tools are available from a variety of database product vendors including IBM Corporation, Oracle Corporation, and Microsoft Corporation. For example, such a management tool could be invoked periodically and run as a timed process to provide update and replication of the IODS database over the various networks it serves.

The functional components of the IODS are shown generally as 500 in FIG. 5. As described previously, the IODS is preferably implemented as a distributed network of servers and routers 501 placed strategically in Internet exchanges and central offices in order to enhance scalability. However, the IODS, despite its name, may also be implemented on one or a relatively small number of closely connected servers in one location. In this implementation, it may be necessary to rely on techniques such as Akamai or Round Robin DNS in order to associate any given NAS with an associated IODS server as the system expands. Regardless of which implementation is selected, the network access point to the IODS is referred to herein as the operator network gateway. Preferably, as will be described in greater detail below, communications between the NAS and the operator network gateway are via an IPSEC-established tunnel between the NAS and the gateway. In the case where the IODS is implemented on distributed servers, preferably standard load balancing algorithms 502 are employed to determine which specific IODS server will provide services to a particular NAS at any given time.

The IODS includes a conventional IP version 4 or IP version 6 TCP/IP stack 503 to enable the IODS to connect to and communicate over the Internet. As persons skilled in the art are aware, the exact configuration of the TCP/IP stack will depend on the network and gateway configurations, as well as the operating system(s) employed, among other factors. The IODS may also include other conventional TCP/IP services 504, such as RSVP.

The IODS also preferably includes a conventional DHCP server 506, which provides IP address ranges to the NAS for allocation to visiting mobile terminals. The IODS also includes routing services 505 to interconnect the IODS network and preferably to support high level services, such as load balancing and content distribution.

The IODS preferably includes secure data communication facilities such as the facilities shown as 507, 508, and 509. Preferably, these facilities provide authentication and secure encrypted communications between the NAS and IODS especially for transmitting proprietary and sensitive data such as accounting data. The preferred implementation employs conventional Internet security protocol (IPSec) and a conventional authentication/encryption/decryption facility or ISAKMP/IKE, operating with a conventional public key infrastructure (PKI) digital certificate service. Alternatively, secure sockets layer protocol (SSL) may be used. As known to those skilled in the art, IPSec is preferably operated in tunnel mode to create a secure communication tunnel between the NAS and the IODS, thus establishing a virtual private network (VPN), and encapsulating data transmitted between the NAS and the IODS. The ISAKMP/IKE facility facilitates mutual authentication between the NAS and IODS, and the negotiation of mutually acceptable cryptographic algorithms and keys to enable encryption and decryption of the transmitted and received data respectively. SSL provides similar functionality. Cryptographic certificates and keys are suitably obtained via a conventional certificate service, many private and commercial sources being well known in the art. The IPSec tunnel may also be used to pass traffic from a mobile terminal through the network to either the operator network gateway closest to the final destination (operating IPSec in tunnel mode), or to the final destination itself (IPSec operating in transport mode).

In the preferred embodiment, the IODS also provides Mobile IP support as shown at 509. Specifications for Mobile IP support 509 for version 4 and version 6 Mobile IP networks are published in IETF RFCs 2002 and IETF Draft “draft-ietf-mobileip-ipv613.txt” entitled “Mobility Support in Ipv6” located at http://search.ietf.org/intemetdrafts/draft-ietf-mobileip-ipv6-13.txt. Mobile IP support enables the IODS to redirect packets transmitted on the network to roaming mobile terminals without having to recontact the mobile terminal's home agent each time.

Preferably, the IODS also provides support for conventional http and https (secure) services. The IODS employs a conventional http agent, for example, to permit resource providers to register and publish resources, and subscribers to view and update their account information.

The IODS also preferably includes support for conventional IP telephony services 511 and credit card processing 512. The credit card processing component 512 preferably handles online processing of credit card information to provide immediate network access to new subscribers. A commercially available product suitable for this purpose is sold under the name “Cash Register” by Cybercash, Inc. Other such suitable facilities are well known to those skilled in the art and need not be described in detail.

The IODS also preferably includes conventional Lightweight Directory Access Protocol (LDAP) and LDAP replication and update (LDUP) interfaces 513 to enable accessing online directory services via a standalone LDAP directory service or a directory service back-ended by X.500. These interfaces also preferably facilitate access to and operation with distributed LDAP services.

If desired, IODS may also include interfaces for other databases 514 as well, such as Netware Directory Services, or telecommunication carriers' databases for cross-authentication purposes.

IODs also preferably includes legacy interfaces for authentication, authorization, and accounting (AAA) 515. The AAA interface 515 is based on conventional LDAP running over IPSec or SSL. Its primary role is to receive equipment (MAC) addresses of mobile terminals and verify they are registered in the IODS database. Once it is verified that an address is present in the database, indicating a registered subscriber, it will respond to the NAS with the subscriber's service plan. It also preferably receives network useage records from each NAS periodically, e.g., every sixty seconds, for updating the session records of the IODS database. Such records preferably include start and end transmission times, number of bits transmitted and received, and network resources contacted. Network resources visited information is preferably treated as confidential to the subscriber and is encrypted with the subscriber's public key to prevent access by the integration provider.

The IODS also preferably includes a database monitoring service 531. Database monitoring service 531 receives triggers generated by the IODS database shown in FIG. 2, and transfers them to the appropriate network communication protocol or service, such as SNMP, to act upon. This service is particularly useful in detecting and acting upon fraud. Various event monitoring services for handling such database maintenance issues are commercially available currently. For example, in the case of Windows 2000, the Microsoft SQL Server product provides functionality to log database events to an event log. Other products, such as Hewlett Packard's Manage X, permit a network administrator to define events, the occurrence of which will result in alerts being sent. The alerts can be sent via email, or to a management console, can be converted to SNMP, or can trigger automatic execution of predetermined routines.

The IODS database 3000, depicted in FIG. 5 in the context of the functional components of the IODS as 520, is illustrated in detail in FIG. 2, and has been previously described. The database contains information that is accessible to the resource provider and the integration operator 521, such as session records of visiting subscribers; data that is only updateable by or accessible to the resource provider 522, such as the resource providers' IP subnets or cryptographic key information; data that is updateable by or accessible only to the integration operator 523, such as IODS configuration information or cryptographic keys of IODS personnel; data that is updateable by or accessible only to the subscriber 524, such as network sites visited and resource contacts; and data to which only the subscriber and integration operator have access 525, such as current account balance. Data of either a subscriber or resource provider that is not to be accessible to the operator is preferably encrypted to prevent access by the integration operator.

The IODS also preferably includes foreign operator interfaces 530, which comprise gateways to enable interoperation with large wireless operators and permit roaming by registered subscribers. For example, these gateways could be used as ESN to MAC address cross-authentication systems, or to permit inter-operator roaming by registered mobile terminals.

The details of operation of the network will now be described with reference to FIGS. 6-12. FIG. 6 shows a general overview of the system operation. Generally, when a visiting mobile terminal comes into proximity with a WAP 3, 4, the mobile terminal begins to receive radio broadcasts from the WAP announcing the WAP's presence. In response, the mobile terminal initiates negotiation of a communication link with the WAP in step 700. As described previously, depending upon the manufacture and configurations of the mobile terminal and the WAP, the communication link negotiated may be a secure layer 1 or 2 encrypted link, or may be an open link. Details of the negotiation process are described herein, but for present purposes, it is sufficient to note that the negotiation process is as specified by the published IEEE 802.11 standard.

Once a communication link is established between the mobile terminal and the WAP, the WAP begins forwarding packets and/or frames from the mobile terminal to the NAS 7. The NAS parses the mobile terminal's MAC or equipment address from the packets or frames and uses the address to determine if the mobile terminal is a registered subscriber in step 800. Essentially, as described previously, authentication of the mobile terminal is accomplished by comparing its MAC or equipment address to a list of such addresses in the NAS′ local database or the IODS master database to see if the mobile terminal has previously registered as a subscriber.

If the mobile terminal's MAC or equipment address matches an address in the NAS′ local database or the IODS master database, the mobile terminal is generally considered authenticated. The NAS next obtains an IP address assignment for the mobile terminal in step 1100 via a local DHCP relay agent or DHCP server, and allocates the mobile terminal network resources, e.g., bandwidth, in step 900. Bandwidth is allocated to the mobile terminal by the bandwidth allocation manager process running under control of the NAS.

Once the mobile terminal has been allocated an IP address and network resources, it may access the network. The NAS monitors the mobile terminal's network access activities and generates session accounting data for billing and other purposes in step 1000. However, some network access activities may indicate fraudulent activity by the mobile terminal. If the NAS detects such activity in step 1200, it takes appropriate remedial action.

Finally, in step 1600, the NAS manages and processes real time network applications for registered, authorized mobile terminals. Such applications may include file transfers, Internet access, web browsing, e-mail, and real time conferencing, such as VoIP and video conferencing, for example.

FIG. 7 illustrates the details of the communication link negotiation process between mobile terminals and the WAPs. Prior to or during a trip away from its own home network, a user may consult a coverage map in step 100 to determine where WAPs are available, their coverage, and other information including WAP configuration and the like. Such information is preferably published by the IODS to registered subscribers either in a hard copy format, or more preferably by maintaining the information on a subscriber-accessible web page via the IODS′ http/https services 510. When the subscriber enters radio link range of a WAP in step 101 (or makes a physical connection to the network in a wired network arrangement), the mobile terminal will begin receiving broadcasts from the WAP announcing its presence. The mobile terminal then sends the WAP a request to negotiate a link at 102. As shown at 103, 104, the mobile terminal may request a link with the WAP in one of four modes, depending on its configuration. The modes are: encryption required, encryption requested, open (clear text) required, and open requested. As described previously, whether the mobile terminal attempts to establish an encrypted or an open link depends upon its own internal configuration. Regardless of the link mode, the link layer communications between the mobile terminal and the WAP are preferably carried out according to the IEEE 802.11 or 802.15 (Bluetooth) standards, depending upon which standard is implemented in the mobile terminal and the WAP.

If the mobile terminal requests or requires an encrypted link, and if the WAP's encrypted link policy is compatible with the mobile terminal's request, e.g., if the WAP is configured to accept an encrypted link request in either mode, an encrypted link (layer1/2) may be possible. There are two methods of processing the mobile terminal's request, depending upon whether the WAP is programmatically controllable by the NAS or not.

The first method is applicable to the embodiment where the WAP does not have an API through which the NAS can control the WAP, shown as 107. In this embodiment, the WAP determines whether it has a set of native keys stored locally at 108. Currently available WAP devices are generally capable of locally storing 32 to 64 40-bit or 128-bit native keys. Typically, a network administrator selects these keys and configures the WAP with them using a telnet or web interface connection, for example, when the administrator installs the WAP in the network. Similarly, the network administrator may configure mobile terminals which are authorized clients of the network with one or more of the WAP's native keys to enable the WAP and mobile terminals to establish an encrypted link. If either the WAP or a mobile terminal is not configured with keys, or if they are configured with keys, but none of the keys match, then it is not possible to establish an encrypted link layer session between the mobile terminal and the WAP, as indicated at 115. Even if the WAP and the mobile terminal are both configured with matching keys, they still may be unable to negotiate an encrypted link. The reason for this is that manufacturers of current WAP and mobile terminal products sometimes implement their encryption algorithms slightly differently. As a result, it sometimes happens that even a mobile terminal and a WAP sharing the same key will be unable to establish an encrypted link. Thus, the most likely instance in which an encrypted link will be possible in this embodiment is when the WAP and mobile terminal both belong to the resource provider's local network, and when they are both made by the same manufacturer. However, if the WAP and mobile terminal have matching native keys and if their respective encryption algorithms are compatible, the WAP preferably responds to the mobile terminal's request by issuing the mobile terminal a set of challenges encrypted with whatever limited number of native cryptographic keys it has at 116, and an encrypted link is established at 119.

A different mechanism is required to provide the WAP's native key(s) to mobile terminals that are visiting the resource provider's network and that are not clients of the network and configured by the resource provider. In this instance, the resource provider may disclose the WAP's native key(s) directly or indirectly via the IODS to authorized subscribers and other resource providers who may seek network access via the WAP. Such disclosure may occur as a general distribution of such information to all subscribers and resource providers by the IODS, recognizing the security concerns raised by such a general distribution of information. More preferably, it may be somewhat more secure for the IODS to only disclose or distribute such information to those subscribers and resource providers with a need to know the key(s) for specific WAPs. For example, when a subscriber registers, the IODS may use secure sockets layer (SSL) to communicate to the subscriber the keys for WAPs in or near the subscriber's home area, unless keys for other WAPs in specific areas are specifically requested. This may be implemented as part of the registration process, or by permitting existing subscribers to request keys for additional sites through a web page or the like as the need arises.

Those skilled in the art will recognize that while distributing the WAPs' native keys will provide some degree of security, the level of security provided is not nearly as strong as provided by a public key system. However, absent such a key distribution scheme, essentially only users of the resource provider's private network whose mobile terminals will have already been configured with the key(s) for that network's WAP(s) will be able to successfully negotiate an encrypted link layer session, which is not the preferred arrangement.

Once subscribers have the WAP's key(s), they can configure their mobile terminals accordingly. If the mobile terminal negotiating with the WAP has been configured with one or more cryptographic keys for the WAP, it responds to the WAP's encrypted challenges by attempting to decipher them using its internally-stored key(s), and responding to the WAP. If the mobile terminal and WAP share the same key(s), as shown in step 114, and if the mobile terminal is successful in deciphering and responding to the WAPs challenges, the mobile terminal and the WAP enter into a conventional negotiation for an encrypted link layer connection in step 116. If the negotiation is successful, an encrypted radio link is established at step 119.

However, if the mobile terminal and WAP do not share the same encryption key(s), as shown in step 115, so that it is not possible to establish a link layer encryption connection, or if the connection cannot be made for whatever other reason, preferably either the mobile terminal or the WAP will issue a request to negotiate an open session in step 104. This so-called “dual mode” approach to establishing a communication link comprises the most preferred embodiment of this aspect of the invention. Assuming the WAP is configured for and is capable of establishing an open session connection, it will accept the request for an open session in step 112, and offer to establish an open session link with the mobile terminal in step 117. However, if for whatever reason the WAP is not configured for or is not capable of communicating in an open session environment, as shown in step 113, and requires an encrypted connection, which is not preferred, the WAP will not accept the request to negotiate an open session from the mobile terminal and will terminate the session in step 124. As a result, the mobile terminal is denied access, as shown in 125. Similarly, if the mobile terminal declines the WAP's offer to establish an open session link in step 121, the WAP will terminate the session in step 124. Preferably, the WAP is configured for and is capable of generating SNMP events, and will generate and log such an event when there is a failure to establish a link with a mobile terminal, as shown at 123. Preferably, the NAS periodically polls for SNMP events via its SNMP component 41, as shown in FIG. 3, and reports the failure to the IODS to enable any necessary or desirable processing to be performed.

If, however, the mobile terminal accepts the WAP's offer to establish an open session link in step 120, then the WAP will negotiate and establish an open session link with the mobile terminal in step 120 according to the conventional wireless network communication standards referred to herein. The WAP will then begin forwarding packets from the mobile terminal to the NAS, which will initiate authentication of the mobile terminal, as shown at 200.

A second method of processing the mobile terminal's request for an encrypted link preferably takes place when the WAP has an API that enables programmatic control by the NAS, as shown at 106. This is the most preferred embodiment of this aspect of the invention. In this circumstance, upon receipt of the request, if no native WAP keys are available, or if no native keys produce a match, the WAP forwards the mobile terminal's MAC address or other unique equipment identifier to the NAS with a request to update keys at 109. Also at 109, the NAS then attempts to match the MAC address to the MAC address of a registered subscriber in its local database. Failing to find a match there, it preferably communicates with the IODS and attempts to find a match in the adapter table 3400 of the IODS master database 3000. If no match is found in either database, the NAS reports to the WAP at 130 that no encryption key exists for the mobile terminal and from there the mobile terminal's request is processed from step 115 as if the WAP and mobile terminal were unable to establish an encrypted session, as described above. However, if a match is found in either the NAS′ local database or the IODS master database, as shown at 129, the NAS preferably retrieves the cryptographic key(s) corresponding to the registered subscriber and mobile terminal from either its local database or the adapter table 3400 of the IODS master database. Alternatively, if either the local database or the IODs database contains a match for the MAC address, but no key(s) are associated with the mobile terminal, the NAS may attempt to locate the corresponding key(s) by contacting a trusted third party foreign database, such as one of the well known depositories of public keys. Wherever it locates the corresponding key(s), the NAS sets the new key in the WAP at 131 and the WAP's key store is updated with the corresponding key(s) at 114. The WAP then issues a challenge to the mobile terminal encrypted with the mobile terminal's key(s). If the mobile terminal successfully deciphers the encrypted challenge and responds to the WAP, the WAP and mobile terminal enter conventional negotation for an encrypted link in step 116. Assuming the negation is successfully completed, an encrypted radio link is established in step 119. Once the link is established, the host has layer 2 access to the network. Any network activity by the mobile terminal thereafter, results in the transmission of packets over the network. The WAP forwards these packets from the mobile terminal to the NAS, which recognizes the presence of a new MAC address on the network and initiates authentication procedures with respect to the mobile terminal in step 200.

FIG. 8 illustrates the detailed operations carried out by the NAS to authenticate mobile terminals connecting to the network. In order for a mobile terminal connected to the network to transmit packets to another network node, the mobile terminal must know the network configuration. Conventional facilities for that purpose are widely known to those skilled in the art and are published in various IETF RFCs. Typically, the mobile terminal will use one of two conventional facilities to determine the network configuration. The mobile terminal can issue a router discovery request using either its Mobile IP stack as shown at 801, or using the auto configuration facilities of IP vers. 6 as shown at 803. Alternatively, the mobile terminal can issue a dynamic host configuration protocol (DHCP) request over the network as shown at 802. Each of these facilities in turn automatically transmits an address resolution protocol (ARP) request over the network to obtain the physical hardware (MAC or Ethernet) address of the node to which the mobile terminal will transmit packets. The ARP request, which by definition includes the MAC address of the mobile terminal, is detected by the network's ARP server, in this case the ARP 23 component of the NAS′ network stack 25, illustrated in FIG. 3. The ARP server typically maintains an ARP cache of resolved addresses, i.e., corresponding IP and hardware addresses. The ARP server updates the cache with the mobile terminal's corresponding IP and MAC addresses obtained from the ARP request in step 804.

Preferably the NAS maintains in its local database a replication of the IODS′ adapter table 3400 with the addresses of each registered mobile terminal. Also preferably, the ARP server is configured with a conventional event generator facility such as SNMP or “Sockets,” so that whenever the ARP cache is updated with a new MAC address on the NAS′ downlink, the server generates an event to the gatekeeper, as shown in step 805. The gatekeeper process is then activated at 806, and the gatekeeper then queries the NAS′ local version of the adapter table in step 807. Alternatively, the gatekeeper 24 process may periodically query the ARP cache on a fixed periodic basis at selected intervals as a time initiated process to determine if any new mobile terminals have connected to the network. Persons skilled in the art will realize that in this case, the interval at which the gatekeeper polls the ARP cache should be set shorter than the interval at which the ARP cache is purged, if any.

Upon comparison of the MAC addresses in the ARP cache with the MAC addresses in the NAS′ local database, the gatekeeper will either find a match, indicating the mobile terminal belongs to a registered subscriber, as shown at 808, will find a match but determine the MAC address has been blacklisted as shown at 810, or will not find a match as shown at 809.

If the gatekeeper fails to find a match in the NAS′ local database, it will then query the adapter table 3400 of the IODS master database 3000 over the NAS′ uplink in step 811. As a result of this query, the gatekeeper determines either that there is no match for the MAC in the IODS database in step 813, indicating the mobile terminal does not belong to a registered subscriber, or that there is a match at step 808, indicating the mobile terminal belongs to a registered subscriber, or that there is a match but that the MAC is associated with a “black-listed” account at step 810.

In the event the gatekeeper finds no match for the MAC address in either the NAS′ local database or in the IODS master database, it initiates a registration procedure. At step 825, the gatekeeper assigns a temporary IP address to the mobile terminal to enable the mobile terminal and the NAS to communicate. Preferably the temporary IP address assigned is in the NAS′ public subnet and is leased for a relatively short time period, for example five minutes. Also, as shown at 814, any attempts by the unregistered mobile terminal to access the Internet are diverted to a registration web page on the NAS, via the NAS′ http/https servers 37, illustrated in FIG. 3. If upon accessing the registration page at 826, the user determines to register as a subscriber, the http/https servers preferably present a registration page containing a registration form requiring certain information from the user. The http/https servers may also set a special flag in the adapter state table 3700 indicating the mobile terminal is connected to the network for the first time. Setting this flag ensures the newly registered subscriber will have access to the network regardless of the state of the resource provider's network access policies.

The registration process involves verifying the information provided on the registration form by the would be subscriber, i.e., registration form validation. The registration form validation has two components: (1) syntactic validation, and (2) information validation. Registration form validation is preferably processed by the NAS. In the syntactic validation component, the NAS verifies the set of fields entered by the user on the registration form meet simple html form rules, such as the entered last name having at least one letter in it. If the form passes syntactic validation, the NAS preferably forwards the data to the IODS for information validation. To validate the information, the IODS preferably attempts to create unique new subscriber, subscriber service plan, and mobile terminal network adaptor records using the data entered by the would-be subscriber. If the IODS is able to successfully create unique these records, it passes the would-be subscriber's credit card information to the credit card processor for processing. If the credit card information is processed successfully, the IODS creates the new records in the IODS database, along with an associated SLA. The IODS then transmits the data normally fetched by the NAS during user logon back to the NAS, completing the registration process at 827.

If upon accessing the registration page, the unregistered user fails to successfully complete the registration process, or if the unregistered user does not access the registration page, the unregistered user's network access extends only to the NAS or the local private network's gateway controlled by the NAS, as shown at 829. Additionally, if the WAP is programmatically controllable by the NAS, as is preferred, the gatekeeper sends a de-authenticate command to the WAP at 828, which instructs the WAP to terminate the communication link with the unregistered mobile terminal.

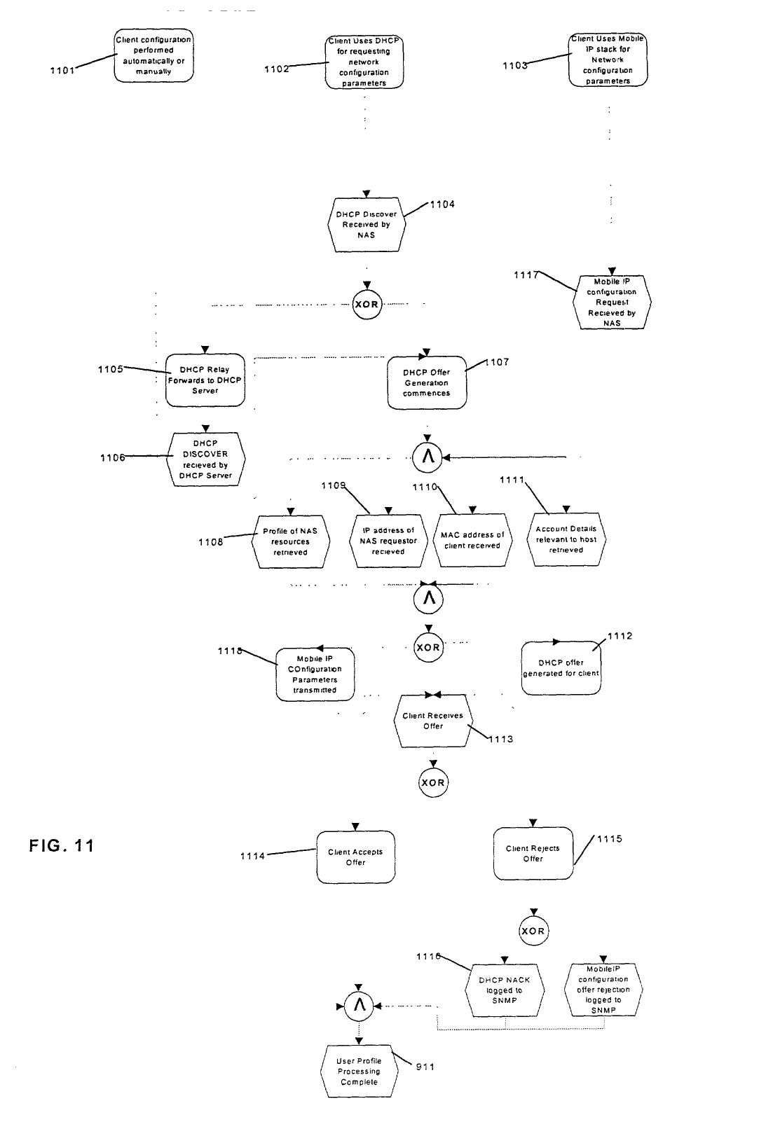

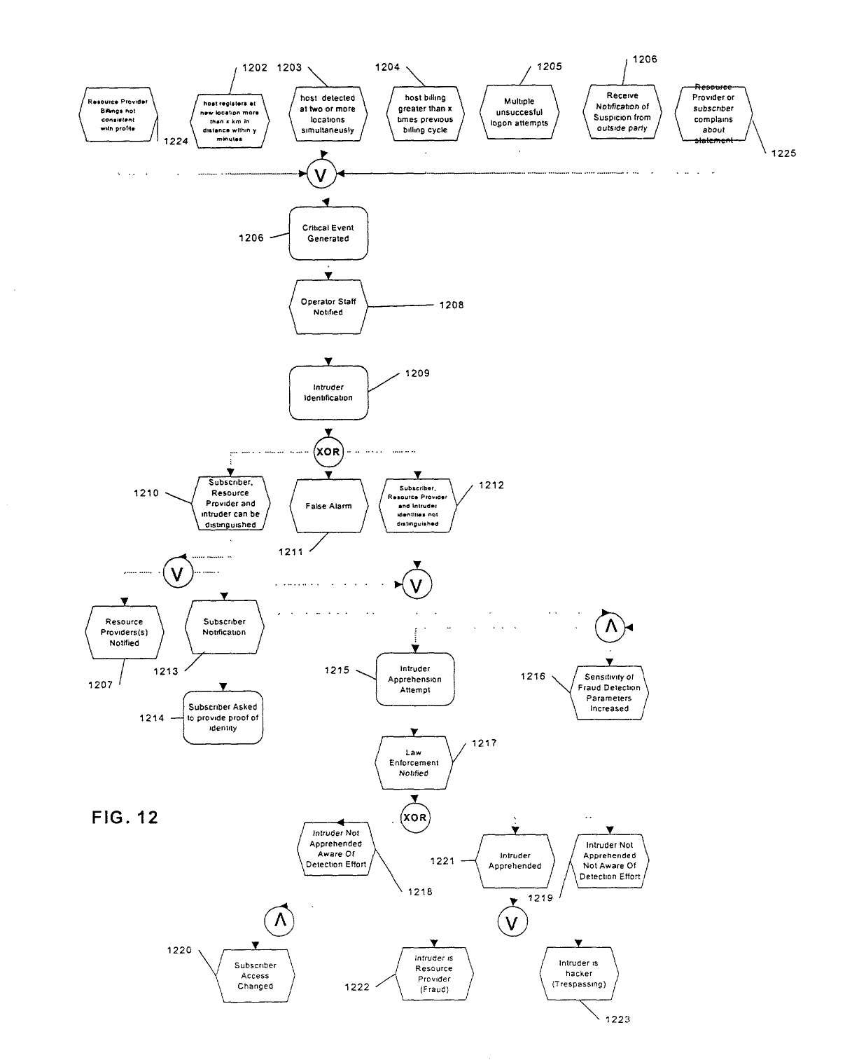

If the gatekeeper finds a match for the mobile terminal's MAC address in either the NAS′ local database or the IODS master database, but determines the MAC address is associated with a “black-listed” account, the gatekeeper preferably initiates security procedures, as shown at 815. Details of these procedures are illustrated and described with respect to FIG. 12. A black-listed MAC address may be indicated by the state of the “lost or stolen flag” stored in the adapter table 3400 of the IODS master database 3000, which is preferably replicated to the NAS local database, at least partially, as previously described. It may also be indicated by a flag or other indication associated with the MAC address indicating the account of the subscriber who owns the mobile terminal is in bad standing, or has been identified as previously having accessed the network without authorization, e.g., a hacker or the like.

If the subscriber completes a successful registration at 827, or if the gatekeeper finds a match for the MAC address in either the NAS′ local database or the IODS′ master database, and if the gatekeeper determines the MAC address is not black-listed, it then considers the account to be a registered account in good standing as shown at 808. The gatekeeper then proceeds to process the subscriber's service plan at 821. In processing the subscriber's service plan, the gatekeeper retrieves the subscriber's service plan information and the resource provider's access policies for visiting mobile terminals from the local versions of the policy table 3500 and the bandwidth access policy table 3650 respectively in the NAS′ database, or if not there, from the IODS master database. The gatekeeper also obtains information concerning the network's available resources from the BAM. The gatekeeper then performs a comparison to determine if the network access provided for in the subscriber's service plan is within the scope of network access granted to visiting mobile terminals in the resource provider's access policies, and if sufficient network resources are available to accommodate the visiting mobile terminal. If the gatekeeper determines the access set forth in the subscriber's plan is permitted, and if sufficient network resources, e.g., bandwidth, are available to accommodate the visiting subscriber, as shown at 822, the gatekeeper initiates three operations 816, 817, and 818.

At 816, the gatekeeper copies certain user profile information from the IODS database to the NAS′ local database. The user profile information preferably includes the subscriber's identification information from the subscriber table 3100, and the mobile terminal information from the adapter table 3400.

At 817, the IODS may optionally communicate with any previous NAS with which the subscriber has opened a session and have the previous NAS close that session in favor of the new session being opened with the new NAS.

At 818, the gatekeeper modifies the state of the MAC address in its IP filter 26 from “do not forward” to “forwarding allowed.” At this point, the gatekeeper only updates the IP filter associated with its own uplink port to enable the visiting subscriber to access the uplink port and thus the Internet. The gatekeeper does not update the IP filter associated with its private network. This is addressed separately when the subscriber's security policy is processed in connection with host resource allocation processing at step 820.

At this point, the visiting mobile terminal is authenticated and has basic authorization to access the Internet via the NAS, as shown at 819. It is preferred that the visiting mobile terminal be authorized for at least basic access to the NAS′ uplink prior to a complete allocation of network resources being made. This is to prevent errors and excessive retransmissions if the visiting mobile terminal requires essential network services during the time the resource allocation process is being carried out. Once the visiting mobile terminal is authenticated, the gatekeeper initiates the host resource allocation process at step 820.

If, however, the gatekeeper determines at 824 that the access provided in the subscriber's service plan is incompatible with the resource provider's policies concerning visiting subscriber access, or that insufficient network resources are available to accommodate the visiting subscriber, or if the resource provider's or subscriber's policies require the user to log onto the network, the gatekeeper redirects the visiting subscriber back to the registration process. The registration page preferably contains error messages, which will indicate to the visiting subscriber the reason for the failed access, if any. In addition, the registration page may aid the visiting subscriber in attempting to correct the situation. For example, the resource provider's network access policy for visiting subscribers may specify that only such subscribers with priority service plans will be granted access. This could be the case, for example, if the resource provider has a heavy load of private network clients requiring public network access. The resource provider may thus determine that, given the limited availability of the network's bandwidth resources for visiting subscribers, the network can only accommodate those visiting subscribers who have priority service agreements. In that case, the registration page may offer the visiting subscriber the opportunity to upgrade its service plan from a non-priority plan to a priority plan. Still further, the registration page may provide the visiting subscriber information concerning the availability of network resources to visiting subscribers over the past several days or week to give the visiting subscriber an indication if and when network resources might become available. For example, the information may indicate to the visiting subscriber that additional network resources routinely become available after 6:00 p.m., when network traffic due to local private network clients subsides. If the visiting subscriber determines not to upgrade its service agreement, or if that is not possible, the gatekeeper will initiate de-authentication and termination of the link with the visiting mobile terminal as shown at 828. If the subscriber is redirected to the registration page because logon is required, the registration page preferably provides authentication of the user and logon processing at 840 and 841, for example requiring the subscriber to enter a correct logon name and password. If logon is unsuccessful after a preselected number of attempts, shown at 843, the subscriber is again directed to the registration page. If logon is successfully completed at 842, the process proceeds to carry out the operations at 816, 817, and 818 and to complete the authentication process at 819.

FIG. 9 illustrates the details of the host resource allocation process. In this process, the gatekeeper allocates network resources to the visiting subscriber and updates certain of the subscriber's records. At 901, the gatekeeper retrieves the visiting subscriber's user profile and service plan information, preferably from the NAS′ local database, but if not there from the IODS master database. The gatekeeper then initiates four threads at 902, 903, 904, and 905.

At 902, the gatekeeper parses the visiting subscriber's service agreement from the user profile and determines the level of service specified by the agreement. Employing the BAM 28 process, and based on the level of service specified in the agreement, the gatekeeper determines a corresponding baseline QOS level for the visiting mobile terminal and allocates a baseline bandwidth, as described in detail in connection with FIGS. 17 and 18. The gatekeeper preferably passes these parameters to the existing QOS service, for example, RSVP, for implementation at the NAS′ applicable ports. If the NAS is not itself the router between the WAPs and the rest of the network, for example in the alternative embodiment illustrated in FIG. 13, the NAS must update these parameters on the router.

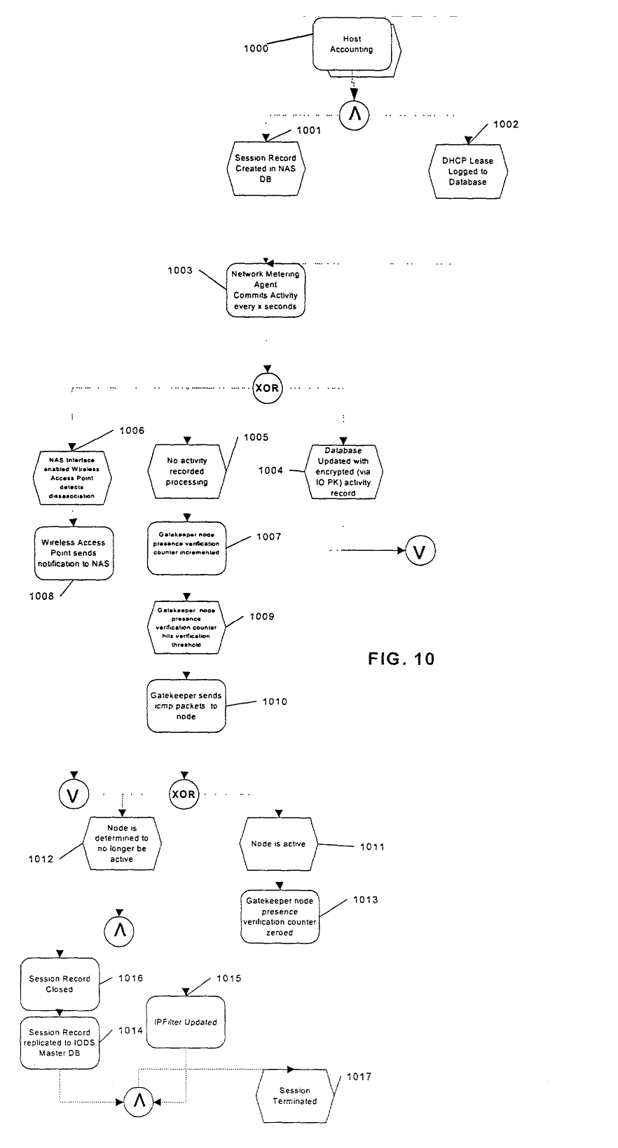

At 905, the gatekeeper associates an IP address with the visiting mobile terminal. This is typically accomplished in conventional fashion through the NAS′ DHCP or DHCP relay component 31 in the case of networks adhering to IETF IP vers. 4 standards. In networks adhering to IETF IP vers. 6 standards, conventional router discovery and auto configuration are employed. Further details of this process are illustrated and described with respect to FIG. 11.

At 904, the gatekeeper updates the location of the visiting mobile terminal in the adapter state table 3700 of the IODS master database 3000. This is done to facilitate locating the mobile terminal for routing real time protocols and inbound telephony communications to the mobile terminal, as shown at 907.

At 903, the gatekeeper processes the subscriber's security policy. The gatekeeper preferably retrieves the subscriber's security policy from the local version of the adapter table 3400 in the NAS′ database, and determines whether the subscriber's security policy permits access to the local private network, which is normally the case if the subscriber is also an authorized client of the private network. If access is permitted, as shown at 908, the gatekeeper updates the IP filter 26 associated with the NAS′ private network port at 910 to permit the mobile terminal access to the local private network. If access is not permitted, as shown at 909, the gatekeeper does not update the IP filter and the mobile terminal is then not permitted to forward packets into the local private network.

This completes the gatekeeper's processing of the user profile, as shown at 911. Next, the gatekeeper turns to its accounting and session management procedures, as shown at 1000.

FIG. 10 illustrates the details of the gatekeeper's accounting and session management procedures. In these procedures, the gatekeeper initializes and updates the subscriber's session records, initializes and updates the subscriber's accounting records, and monitors the subscriber's use of the network. At 1001, the gatekeeper initializes the subscriber's session record by creating a local version of the session records table 3750 in the NAS′ local database. The gatekeeper initializes the session record with the mobile terminal's MAC address, the time the session started, and the mobile terminal's location. If the NAS′ local database is being used to store DHCP parameters for the mobile terminal in connection with the NAS′ DHCP/DHCP relay component 31, the gatekeeper also logs the DHCP IP address lease to the local database at 1002.

At 1003, the network metering or statistics collection agent 29 of the NAS, shown and described with respect to FIG. 2, periodically checks the network activity of the subscriber. This is preferably done either by polling the operating system's network API, as previously described, or via SNMP. Preferably, each time the agent checks the subscriber's network activity, it determines which network sites the subscriber has visited and how many bits it has sent and received. The agent 29 may employ conventional operating system facilities for these purposes. For example, in the case of Windows 2000 and Windows NT, a special driver called the network monitor agent can be accessed via an API to poll the session state and commit that information to the NAS′ local database. The agent preferably continues to periodically check the subscriber's network activity until the subscriber affirmatively disconnects from the network or is determined to have become inactive.

If the WAP is of the preferred type having an API and being programmatically accessible by the NAS, it is preferably configured to notify the NAS when it detects disassociation of the mobile terminal from the network, as shown at 1006 and 1008. This can be accomplished easily if the WAP supports SNMP, by configuring it to recognize the disassociation as an event and to provide network notification to the NAS upon detection of the disassociation. When the WAP notifies the NAS the mobile terminal has disassociated from the network, the NAS changes the mobile terminal's status in the local version of the adapter state table 3700 to “Node No Longer Active,” at 1012 and proceeds to close the session.

If the NAS has not otherwise been notified the mobile terminal has disassociated from the network, the agent 29 preferably checks whether the mobile terminal has become inactive each time it checks the mobile terminal's network activity. At 1005, the agent 29 determines whether there has been any network activity by the mobile terminal since the last check. This can be done by comparing the number of bits sent and received by the mobile terminal during the session at this check to that number recorded at the last check. If no activity has taken place since the last check, the agent increments a node inactivity counter at 1007 and checks to see if the counter has exceeded a predetermined threshold value at 1009. If the threshold value has been exceeded the agent sends an ICMP packet to the mobile terminal at 1010 and waits for a response. If no appropriate response is received from the mobile terminal within a predetermined time, the agent determines the mobile terminal is no longer active on the network at 1012 and proceeds to close the session. However, if art appropriate response is received from the mobile terminal within the predetermined time, the agent determines the mobile terminal is still active at 1011, zeroes the inactivity counter at 1013, and returns to periodic checking of the mobile terminal's network activity, as shown at 1003.

Preferably each time the agent checks the subscriber's network activity, it also updates the session record in the NAS′ local database with the number of bits sent and received, and the sites visited by the subscriber. The latter information is preferably encrypted with the subscriber's public key, if available, to prevent unauthorized access.

To close a session, the gatekeeper marks the session record closed in the NAS′ local database at 1016 and replicates the local session record to the session records table 3750 of the master IODS database 3000, shown in FIG. 2. Preferably the session record is encrypted with the integration operator's public key prior to replication to prevent unauthorized access. Also preferably, an appropriate X.509 certificate revocation list (CRL) is consulted prior to the encrypted transfer to ensure the integration operator's public key is still good. At 1015, the gatekeeper also updates the IP filters 26 for the appropriate ports, i.e., downlink, uplink and private network ports, as necessary to remove any permissions for the mobile terminal to forward or receive packets over the network. The session is thus terminated, as shown at 1017.

Those skilled in the art will realize that many other processes may be on-going in the network simultaneously with the gatekeeper processes being described. For example, legacy AAA and remote client use processes, Mobile IP home and foreign agent activities, IPSec, DHCP, and router discovery processes all may be on-going. As these processes are all conventional in nature, and are not altered by the gatekeeper processes except as otherwise described herein, it is not necessary to describe them in detail herein and such description is therefore omitted.

FIG. 11 illustrates the details of the procedures by which the gatekeeper allocates an IP address to a mobile terminal as identified at location 905 of FIG. 9. A mobile terminal will acquire its network configuration parameters, including an IP address, in one of three ways. The mobile terminal can either manually or automatically self-configure its parameters, as shown at 1101, the mobile terminal can employ dynamic host configuration protocol (DHCP) procedures, as shown at 1102, or the mobile terminal can obtain its configuration parameters via its Mobile IP stack, as shown at 1103.

As shown at 1101, in networks conforming to the IETF IP vers. 6 standards, the mobile terminal will send a router discovery request to determine the network configuration and will then automatically self-configure its network parameters. This can also be done manually. In this instance, the gatekeeper is not involved in allocating an IP address to the mobile terminal, and immediately proceeds to the host session accounting and management functions illustrated and described in connection with FIG. 10.

In the second approach, shown at 1102, conventional DHCP agent software on the mobile terminal sends a DHCP server discovery request over the network, which is received by the NAS at 1104. If the NAS implements a DHCP relay agent 31 rather than a DHCP server itself, the NAS forwards the request to the relay agent 31, which in turn forwards the request to the DHCP server at 1105 and 1106. When the DHCP server receives the DHCP server discovery request, the DHCP server undertakes to generate a DHCP configuration offer at 1107. The configuration offer includes information obtained by retrieving a profile of the NAS resources at 1108, the IP address of the NAS making the request at 1109, the MAC address of the mobile terminal at 1110, and the subscriber's account details at 1111. The NAS resources include the identification of IP subnets specific to the NAS (such as a private LAN subnet and public network subnet), as well as other IP resources the NAS makes available to clients, such as telephony gateways and various ports. This information, together with the NAS′ IP address and the mobile terminal's MAC address are readily obtained from the DHCP discovery request. The subscriber's account information is obtained preferably from the NAS via its local database or indirectly from the IODS database through the NAS. This account information is preferably used to identify which subnets the subscriber is permitted to access.

Next, at 1112 and 1113, the server generates and sends a conventional DHCP offer including an IP address, to the mobile terminal. The mobile terminal accepts the offer, as shown at 1114, by issuing an acknowledgment of receipt (ACK). If an ACK is received, the IP address has been allocated, and the gatekeeper proceeds to the session accounting and management procedures shown and described with respect to FIG. 10. However, if the mobile terminal rejects the offer, as shown at 1115, the DHCP server preferably generates an event, which is logged to SNMP or a suitable event management and reporting application at 1116. The gatekeeper then proceeds to the session accounting and management procedures of FIG. 10. Failure to transmit an ACK (NACK) is considered a rejection.

The third approach, shown at 1103, presumes the existence of the preferred Mobile IP support component 33 of the NAS, as shown in FIG. 3. In this approach, the mobile terminal issues a Mobile IP configuration request, which is received by the NAS at 1117. Thereafter, the NAS performs the functions identified at 1108-1111 and obtains the necessary Mobile IP configuration parameters. The NAS then transmits the configuration parameters back to the mobile terminal at 1118. Upon receipt at 1113, the mobile terminal either accepts or rejects the parameters at 1114 and 1115. Upon acceptance, the gatekeeper proceeds to the session accounting and management procedures of FIG. 10. Any rejection preferably triggers an event, which is logged to SNMP or a suitable event management and reporting application by the DHCP server. The gatekeeper then proceeds to the session accounting and management procedures of FIG. 10.

FIG. 12 illustrates the details of the security procedures identified generally at location 815 of FIG. 8. In addition, FIG. 12 illustrates the details of procedures for preventing fraudulent tampering with the accounting records. The security procedures are triggered by the occurrence of any of seven security situations.

The first situation is receiving resource provider billings that are not consistent with a predetermined profile. This is shown at 1224. The IODS master database has sufficient information about resource providers to establish a profile for each provider based on such factors as the resource provider's location, cell size, and uplink capacity. Further, the resource provider's location enables the profile to be enhanced with information concerning population and general level of affluence of the population. From this profile information, the integration operator can easily establish algorithms such that when resource provider billings are received, it can be detected whether the billings are out of line with the profile. For example, a resource provider having a 56K connection in rural Idaho might arouse suspicion if it suddenly began submitting bills to the IODS showing very high levels of network traffic.

In addition, resource providers are preferably prevented from creating false billing records by reporting non-existent (virtual) network traffic or by tampering with the NAS′ local database. The gatekeeper preferably encrypts the billing records maintained in the NAS′ local database with the integration operator's public key, as described previously, thus preventing access by an unscrupulous resource provider. Since the gatekeeper cannot be modified by a resource provider, the only way for a resource provider to manufacture traffic through its network connection is to actually forward traffic from a wireless mobile terminal through the local NAS′ uplink port.

The second situation is detecting a mobile terminal connecting to a NAS at a location more than a predetermined distance from the last NAS to which it connected, in less than a predetermined amount of time. This is shown at 1202. The third situation is detecting mobile terminals having the same MAC address attempting to connect or connected to the network at two different locations simultaneously. This is shown at 1203. Each of these situations indicates at least one of the mobile terminals is employing a false MAC address. The location and MAC address of a mobile terminal connecting to the network are logged in the IODS master database at the time of connection, as described previously. Thus, it is relatively easy to detect when the “same” mobile terminal purports to be in two locations at the same time, or at one location at one time, and at another location a certain distance away in less than a minimum time it takes to get there. Those skilled in the art will realize that in determining travel time for this purpose, one must take into account the location of the WAP through which the mobile terminal is connecting. For example, the estimated minimum time to travel between two WAPs located at two different airports might be far less than the estimated minimum time to travel the same distance between two points not connected by commercial air service. Setting of the time parameters should therefore be carefully considered to minimize the occurrence of false alarms.

The fourth situation is detecting that the current billing amount for a subscriber has exceeded a predetermined multiple of the billing amount for the entire last billing cycle, shown at 1204. This situation is easily determined by comparing the current and previous charges to a subscriber in the IODS subscriber account status table 3800 This situation usually occurs due to unauthorized use of the subscriber's mobile terminal by another person, for example due to theft or the like.

The fifth situation is detecting multiple unsuccessful logon attempts, shown at 1205. This situation typically arises with equipment having interactive logon facilities for connecting to corporate networks or the like. Such equipment will automatically attempt to logon at various network connections with which it comes into proximity, but will typically be unsuccessful because it is configured for logon only to the corporate network. Since unsuccessful logon attempts are reported and logged, as described previously, this is a relatively easy situation to detect.

The sixth and seventh situations are receiving information from an outside source, shown at 1206, and receiving a complaint by a resource provider or subscriber about a billing statement, shown at 1225.

Preferably, the network management system, for example, SNMP, is configured such that the occurrence of any of the above-identified situations is identified as an event at 1206. Preferably also, the network management system is configured to notify designated integration operator staff in response to the event at 1208.

Next, an intruder identification process is initiated at 1209. The designated integration operator security staff analyze the available information and attempt to determine if they can distinguish between the subscriber, resource provider and suspected intruder at 1210 and 1212, or if the occurrence is a false alarm at 1211. Assuming the occurrence is determined not to be a false alarm, and the staff is able to distinguish between the three entities, the staff preferably notify the subscriber and resource provider of the occurrence at 1207 and 1213, contact the suspected intruder over the network, and ask it to prove its identity at 1214. This can be done for example by requiring registered subscribers to provide some personal information known only to them as part of the registration process. Information such as a mother's maiden name is a suitable example.

At this point, intruder apprehension may be attempted at 1215 by monitoring the intruder's network activity and attempting to locate the intruder. Law enforcement officials may also be notified at 1217. One of three situations can arise at this point: the intruder is successfully located and apprehended at 1221, the intruder becomes aware of the detection and escapes apprehension at 1218, or the intruder cannot be located and remains unaware of the detection and apprehension attempt at 1219.

In the event the intruder becomes aware of the detection attempt and evades apprehension, preferably the subscriber's access parameters are changed at 1220 to prevent the intruder from gaining further unauthorized access to the network. If the intruder is apprehended, a determination can be made whether the intruder is a fraudulent resource provider or a trespasser, such as a hacker, at 1222 and 1223, and appropriate action can be taken. Additionally, in any situation in which it is determined by the security staff there is an intruder, preferably the fraud detection parameters described above are modified to become more restrictive in the location where the intruder accessed the network and for some predetermined period of time thereafter. After that time, or if the intruder is ultimately detected and successfully apprehended, the fraud detection parameters are preferably reset to their original values.

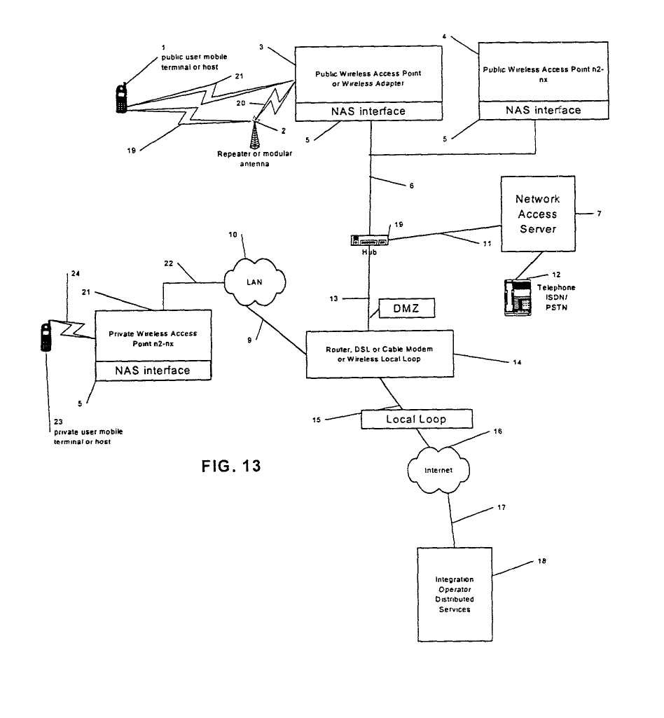

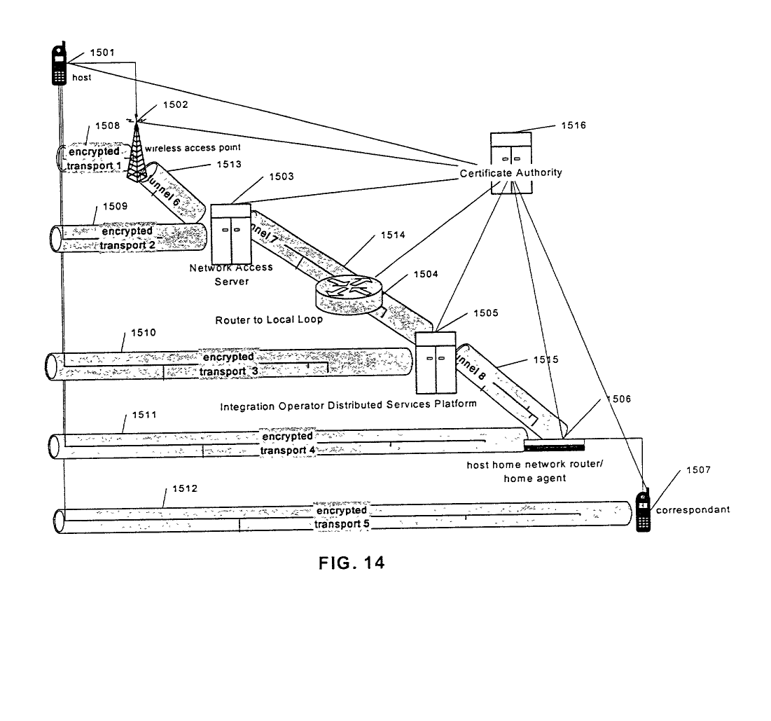

FIG. 14 provides a summary illustration of preferred security arrangements to ensure the confidentiality and authenticity of communications in the present invention. Generally, security is preferably provided by a combination of link layer, network layer, and application layer encryption. FIG. 14 identifies a number of potential cryptographic endpoints in the network, i.e., the mobile terminal 1, WAP 3, 4, NAS 7, local loop router 14, IODS 18, and a potential correspondent node 1507 and its associated home network router or agent 1506. Preferably, each of the end-points employs conventional public key infrastructure (PKI) technology to enable them to negotiate secure channels of communication without necessarily having any previous knowledge of each other. This feature is provided by a conventional certificate authority 1516, which maintains and provides public keys for each of the components, and which is preferably accessible by each of the components either directly, or perhaps indirectly through the IODS.

There are essentially five network communication segments to be secured. Once secured by applying appropriate encryption, these are referred to as “encrypted transports.” The first network communication segment 1508 exists between the mobile terminal and the WAP. This segment is preferably made an encrypted transport by establishing a link layer encrypted session between the mobile terminal and the WAP, if possible. As described previously, there are at least two ways to achieve this. First, if the mobile terminal and WAP are encryption compatible, they may negotiate a link layer encrypted session employing one or more native keys stored locally at the WAP. Alternatively, if the WAP is programmatically controllable by the NAS 7, then the NAS can provide one or more keys from the certificate authority to the WAP, and the mobile terminal can obtain the appropriate keys from the IODS to enable a link layer encrypted session to be established. At worst, if neither approach is available or employed, this segment may need to remain unsecured in order for the mobile terminal to connect to the network.

The second segment 1509 exists between the mobile terminal and the NAS. This segment is preferably made an encrypted transport by providing the mobile terminal with a suitable security client such as IPSec, ESP, or AH, or a legacy remote access or AAA client, such as Radius or Diameter. In that event, encryption is carried out at the network layer 3.

The third segment 1510 exists between the host and IODS. This segment is also preferably made an encrypted transport similarly to the second segment by providing the mobile terminal with a suitable security client such as IPSec, if available, and encrypting at the network layer 3.

The fourth segment 1511 potentially exists between the mobile terminal and the home network router or agent 1506 of a correspondent node 1507. This segment is preferably made an encrypted transport using the IETF Mobile IP standard's Security Association (SA) facility. Alternatively, like segments 2 and 3, a secure remote access client may be provided on the mobile terminal such as Radius, Diameter, PPTP, or IPSec, if available.

The fifth segment 1512 exists between the mobile terminal and a potential mobile, remote, correspondent node 1507. Like the third and fourth segments, this segment is preferably made an encrypted transport using an IPSec or similar security/encryption client on the mobile terminal, if available.

In addition to or as an alternative to the foregoing approaches, some of which may require the mobile terminal to have an additional security client, the applications running on the network will preferably provide encryption at the application level, for example using secure sockets layer (SSL) protocol.

Also, in addition to the foregoing approaches, in each of which the mobile terminal is one of the end nodes, encryption may be provided between intermediary nodes acting as security gateways. This approach does not require the mobile terminal to have a security client such as IPSec to provide encryption. However, it is still preferred that if at all possible the mobile terminal establish a link layer encrypted session with the WAP and preferably the NAS, so that communications with the mobile terminal will be secure end to end. In this approach, the NAS preferably employs IPSec to create a secure communication tunnel 1513, 1514, 1515 to the furthest node that is capable of negotiating a security association with the NAS. This approach has the additional advantage of enabling the NAS to employ the same application classification database as described with respect to the QOS system to determine whether to route traffic via the tunnel, which is slower, or to transmit data unencrypted. For example, if the tunnel's round trip time exceeds 150 ms, and the default route does not, the default route could be used for time sensitive classes of data, for example, voice, while the tunnel could be used for data that is relatively time insensitive, such as email. Still further, with this approach, even if the mobile terminal is unable to establish an link layer encrypted session with the WAP and does not have a suitable security client, security will still be provided between the NAS and other remote network nodes.

Those skilled in the art may realize that encrypting all of the traffic flowing in the network will have consequences with respect to the functioning of the BAM and QOS functions of the system. Thus, it is preferred that QOS information be transmitted in an unencrypted state. This enables the NAS to priorize traffic using RSVP or DIFFSERV, for example, according to the QOS methods and policies described previously.

The foregoing describes presently preferred embodiments of the invention. Persons skilled in the art will realize that numerous additions and alterations may be made to the described embodiments while retaining the features and advantages that characterize the invention and without departing from the spirit thereof. The foregoing descriptions are therefore intended to be exemplary in nature rather than limiting, and the scope of the invention is defined solely by the appended claims as properly interpreted.

What is claimed is:

1. A system for providing terminals controlled access to a public network using the public network connection of a private network, comprising:
a network access point for establishing a network connection with a said terminal;
a network access server;
a first network interface between said network access server and said network access point;
a second network interface between said network access server and said public network connection of said private network;
said network access server being configured to establish and control a network connection between a said terminal having a network connection with said network access point and said public network through said public network connection of said private network without a network connection being established between said terminal and said private network.

2. The system of claim 1 wherein said network access point has a wireless network interface for establishing a wireless network connection with a said terminal.

3. The system of claim 2 wherein said terminal has a wireless network interface for establishing a wireless network connection with said network access point.

4. The system of claim 3 wherein said terminal is a mobile terminal.

5. The system of claim 4 wherein said terminal and said network access point communicate via Bluetooth protocol.

6. The system of claim 4 wherein said terminal and said network access point communicates via IEEE 802.11X wireless LAN protocol.

7. The system of claim 1 including a third network interface between said network access server and said private network to enable network communication between said network access server and said private network.

8. The system of claim 1 wherein said network access server is resident in said network access point.

9. The system of claim 1 wherein said network access server and said network access point are co-resident in a computer.

10. The system of claim 1 wherein said network access server is resident in a computer and wherein said computer comprises an interface between said network access point and said private network.

11. The system of claim 7 wherein said network access server is resident in said third network interface.

12. The system of claim 11 wherein said third network interface comprises a local area network adaptor.

13. The system of claim 1 wherein said network access server comprises software to register terminals and software to limit access to the public network to registered terminals.

14. The system of claim 7 wherein said network access server comprises facilities to prevent access by said terminals to said private network.

15. The system of claim 14 wherein said facilities include facilities to configure separate public access and private access subnetworks.

16. The system of claim 14 wherein said facilities include an IP address filter.

17. The system of claim 7 wherein said network access server comprises software to facilitate encrypting and decrypting data sent and received by said mobile terminal over said public network.

18. The system of claim 1 wherein said network access server comprises facilities for dynamically providing network configuration data to said terminals.

19. The system of claim 1 wherein said network access server comprises facilities to route data communicated to and from said mobile terminal over said public network.

20. The system of claim 1 wherein said network access server comprises software for controlling bandwidth useage by said terminals.

21. The system of claim 1 wherein said network access server comprises software to monitor and record network useage by said terminals.

22. The system of claim 1 wherein said network access server comprises software to provide mobile IP support for said wireless, mobile terminals.

23. The system of claim 1 wherein said network access server comprises a database for maintaining selected information concerning registered terminals.

24. The system of claim 1 wherein said network access server comprises facilities for providing telephony services to said mobile terminals.

25. The system of claim 1 including an integration operator network adapted to communicate with said network access server over said public network, said integration operator network comprising facilities to manage public network access by said mobile terminal through said network access server.

26. The system of claim 25 wherein said integration operator network comprises a central database for maintaining selected information about said network access servers and said registered terminals, and selected network access and useage policies.

27. The system of claim 25 wherein said selected information about said network access servers includes at least one of provider identification, network configuration information, data encryption information, network useage policy information, and provider accounting information.

28. The system of claim 25 wherein said selected information about said registered terminals includes at least one of authorized user identity, terminal address, terminal security policy, terminal service plan identification, data encryption information, terminal status in network, network useage accounting information.

29. The system of claim 25 wherein said selected network access and useage policies include at least one of public network access policy information, bandwidth useage policy information, and network traffic priority policy information.

30. A method for providing terminals controlled access to a public network using the public network connection of a private network, comprising:
providing a network access point for establishing a network connection with a said terminal;
providing a network access server;
providing a first network interface between said network access server and said network access point;
providing a second network interface between said network access server and said public network connection of said private network;
configuring said network access server to establish and control a network connection between a said terminal having a network connection with said network access point and said public network through said public network connection of said private network without a network connection being established between said terminal and said private network.

31. The method of claim 30 including providing said network access point with a wireless network interface for establishing a wireless network connection with a said terminal.

32. The method of claim 31 including providing said terminal with a wireless network interface for establishing a wireless network connection with said network access point.

33. The method of claim 32 wherein said terminal is a mobile terminal.

34. The method of claim 33 wherein said terminal and said network access point communicate via Bluetooth protocol.

35. The method of claim 33 wherein said terminal and said network access point communicate via IEEE 802.11X wireless LAN protocol.

36. The method of claim 30 including providing a third network interface between said network access server and said private network to enable network communication between said network access server and said private network.

37. The method of claim 30 including incorporating said network access server in said network access point.

38. The method of claim 30 including integrating said network access server and said network access point in a computer.

39. The method of claim 30 including incorporating said network access server in a computer that comprises an interface between said network access point and said private network.

40. The method of claim 36 including incorporating said network access server in said third network interface.

41. The method of claim 40 wherein said third network interface comprises a local area network adaptor.

42. The method of claim 30 including providing said network access server with software to register terminals and software to limit access to the public network to registered terminals.

43. The method of claim 42 wherein said software to register terminals is operative to automatically begin a registration process with respect to a said terminal when said terminal is comes within communication range of said network access point.

44. The method of claim 36 including providing said network access server with facilities to prevent access by said terminals to said private network.

45. The method of claim 44 wherein said facilities include facilities to configure separate public access and private access subnetworks.

46. The method of claim 44 wherein said facilities include an IP address filter.

47. The method of claim 30 including providing said network access server with software to facilitate encrypting and decrypting data sent and received by said mobile terminal over said public network.

48. The method of claim 30 including providing said network access server with facilities for dynamically providing network configuration data to said terminals.

49. The method of claim 30 including providing said network access server with facilities to route data communicated to and from said mobile terminal over said public network.

50. The method of claim 30 including providing said network access server with software for controlling bandwidth useage by said terminals.

51. The method of claim 30 including providing said network access server with software to monitor and record network useage by said terminals.

52. The method of claim 33 including providing said network access server with software to provide mobile IP support for said wireless, mobile terminals,.

53. The method of claim 30 including providing said network access server with a database for maintaining selected information concerning registered terminals.

54. The method of claim 30 including providing said network access server with facilities for providing telephony services to said terminals.

55. The method of claim 30 including providing an integration operator network adapted to communicate with said network access server over said public network, said integration operator network comprising facilities to manage public network access by said mobile terminal through said network access server.

56. The method of claim 55 including providing said integration operator network with a central database for maintaining selected information about said network access servers and said registered terminals, and selected network access and useage policies.

57. The method of claim 55 wherein said selected information about said network access servers includes at least one of provider identification, network configuration information, data encryption information, network useage policy information, and provider accounting information.

58. The method of claim 55 wherein said selected information about said registered terminals includes at least one of authorized user identity, terminal address, terminal security policy, terminal service plan identification, data encryption information, terminal status in network, network useage accounting information.

59. The method of claim 55 wherein said selected network access and useage policies include at least one of public network access policy information, bandwidth useage policy information, and network traffic priority policy information.

60. An apparatus for providing mobile terminals controlled access to a public network using the resources of a private network having a network access point for connecting with said mobile terminals and a public network connection for connecting with said public network, comprising:
a network access server having a network interface for making a network connection with said access point and a network interface for making a network connection with said public network connection;
said network access server being operational to control connection between said mobile terminals and said public network through said private network's public network connection without permitting said mobile terminals access to said private network.

61. A distributed system for providing mobile terminals controlled access to a public network using the public network connections of a plurality of private networks, comprising:
a plurality of geographically distributed network access points for establishing network connections with one or more of said mobile terminals;
a plurality of geographically distributed network access servers;
a plurality of first network interfaces, each first network interface for connecting a said network access server with a selected group of said network access points;
a plurality of second network interfaces, each second network interface for connecting a said network access server with a said public network connection of a said private network;
each said network access server being configured to establish and control a network connection between a said mobile terminal having a network connection with a said network access point and said public network through a said public network connection of a said private network without a network connection being established between said terminal and said private network; and
an integration operator network located remotely from at least some of said plurality of network access servers and adapted to communicate with each of said network access servers over said public network, said integration operator network comprising facilities to form said network access servers into a distributed public network access network.
